(19) United States
(12) Patent Application Publication
(10) Pub. No.: US 2026/0059064 A1
(43) Pub. Date: Feb. 26, 2026

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: TAKASHI MORIYA, Kanagawa (JP)

(21) Appl. No.: 19/300,183

(22) Filed: Aug. 14, 2025

(30) Foreign Application Priority Data
Aug. 26, 2024 (JP) 2024-144475

(51) Int. Cl. H04N 1/387; H04N 1/00

(52) U.S. Cl. CPC H04N 1/3877; H04N 1/00708

(57) ABSTRACT

A non-transitory computer-readable storage medium stores an application program which causes an information processing apparatus to perform a control method, the information processing apparatus being connected to a printing apparatus in such a way as to be able to communicate with the printing apparatus, the control method including acquiring information about a paper size of a sheet on which to cause the printing apparatus to perform printing, determining, based on the information about the paper size, whether it is necessary to rotate an image which the information processing apparatus has instructed the printing apparatus to print, and, if it is determined that it is necessary to rotate the image, without causing an operating system (OS) of the information processing apparatus to perform rotation of the image, causing the application program to perform the rotation.

### BACKGROUND

Field of the Technology Aspects of the present disclosure generally relate to an information processing apparatus, a control method for an information processing apparatus, and a storage medium.

### Description of the Related Art

Recently, a universal printer driver (local printer driver) which performs direct communication with an image forming apparatus using an industry-standard protocol such as the Internet Printing Protocol (IPP) has been being considered.

The local printer driver is a driver which is provided by the provider of an operating system (OS) of a client terminal, and is a printer driver which generates print data which printers of a plurality of printer vendors are able to interpret. The local printer driver is capable of communicating with printers of a plurality of manufacturers (makers or vendors).

Therefore, through the use of the local printer driver, the user is allowed to, without having to install a vendor-specific printer driver, transmit a print job to an image forming apparatus.

Additionally, printing using a cloud print service has been being considered. In the cloud print service, the user is required to install a printer driver for the cloud print service (cloud printer driver) on an information processing apparatus.

The cloud printer driver is also a driver which is provided by the provider of an operating system (OS) of a client terminal, and is also a printer driver which generates print data which printers of a plurality of printer vendors are able to interpret. In the cloud print service, an information processing apparatus uses the cloud printer driver to transmit a print job to the cloud print service and the cloud print service then transmits a print job to an image forming apparatus to perform printing.

Since the above-mentioned local printer driver or cloud printer driver handles print jobs to be printed by image forming apparatuses of various vendors, restrictions are imposed on items or functions which are settable as print settings. Therefore, extending, with use of identification information about a printer which is associated with a printer driver, print settings in association with the printer driver has been being considered. This enables implementing a vendor-specific print setting user interface (UI) or print job editing function.

Such an application for extending print settings (a print setting extension application) receives, from an OS, intermediate image data for editing processing expressed by, for example, the “Extensible Markup Language (XML) format, such as the XML Paper Specification (XPS) format. Then, the print setting extension application converts the intermediate image data subjected to editing processing into a page description language (PDL) for printing.

The OS provides a PDL conversion application programming interface (API) for converting intermediate image data into the PDL, and the printer driver or print setting extension application uses the API to convert intermediate image data into the PDL.

Conventionally, in the case of a preprinted sheet, which is a sheet of paper for printing having a logo or stamp preliminarily appended thereto and in which there is a designation of the direction thereof with respect to a specific sheet of paper, there has been a method for sharing the responsibility of rotation processing for pages between a printer driver and a printer, as described in Japanese Patent Laid-Open No. 2006-018742.

Moreover, in the case of a sheet of paper having a flap portion at one end of the sheet, such as an envelope, depending on the sheet feeding structure of a printer, the feed direction of an envelope may be designated in such a way as to prevent the flap portion from becoming an encumbrance to the conveyance of the sheet.

Moreover, depending on types or structures of printers, the feed direction is not necessarily the same. For example, as described in Japanese Patent Laid-Open No. 2023-110778, there is also a printer in which the flap portion of a Nagagata envelope (a vertically elongated envelope) is set as a trailing edge side of the sheet to be fed to the printer and the Nagagata envelope is fed from a rear tray as illustrated in FIG. 11A.

On the other hand, there is also a printer in which sheet feeding is performed from the long edge (no flap portion attached thereto) of a Nagagata envelope (a vertically elongated envelope). As described in Japanese Patent Laid-Open No. 2023-110778, there is a method in which print settings including paper information and drawing data including margins are acquired by the print setting extension application and the downstream side in the conveyance direction of the sheet corresponds to the lower side of the drawing data. In that case, the direction of data about a vertically elongated original image illustrated in FIG. 11A is reversed by 180 degrees and, then, the data is transmitted to the printer.

Such a printing system is equipped with any type of PDL from among a plurality of PDLs, and is compatible with a type of format such as Portable Document Format (PDF) or PWG-Raster (a raster image format defined by the Printer Working Group (PWG) for use with IPP printers). In a case where the printing system is equipped with the PWG-Raster format, it is defined that the client terminal side, as the responsibility thereof, appropriately rotates an original image in such a way as to align with the conveyance direction of each paper size compatible with a feed tray (an example of a feeding portion) and, after that, converts the rotated original image into a raster image for printing and transmits the raster image to the printer.

In PWG 5100.7-2023 IPP Job Extensions v2.1 (The Printer Working Group, 2023, p.39), the method of building, as a capability response of the printing apparatus, database information composed of a combination of paper size, paper type, a feed tray, the direction of paper, and the rotation angle of paper and acquiring the database information from a terminal by the IPP is defined.

However, in the case of configurations such as described in Japanese Patent Laid-Open No. 2006-018742 and Japanese Patent Laid-Open No. 2023-110778, there is an issue in which, even in either case, in a printing environment satisfying the following three conditions, an image may be doubly rotated by the OS-standard printer driver and the print setting extension application provided by the vendor:
The OS-standard printer driver has the function of automatically rotating an image according to the IPP standard.
The printer has a rotation attribute conforming to the IPP standard.
The print setting extension application rotates an image according to the paper size and the direction of paper set by the user.

As a result, in the case of performing printing on an envelope illustrated in FIG. 11A with vertical writing, since an original image is doubly rotated by 180 degrees, the original image is transmitted in the state of having returned to the original angle thereof, so that the content of a printing result to be printed by the printer may become an output turned upside down.

In this way, duplicate processing caused by an image rotation performed by the OS and an image rotation performed by the application program occurs, so that an intended printed result cannot be obtained.

### SUMMARY

Aspects of the present disclosure are generally directed to obtaining of a printed result as intended by the user.

According to an aspect of the present disclosure, a non-transitory computer-readable storage medium stores an application program which causes an information processing apparatus to perform a control method, the information processing apparatus being connected to a printing apparatus in such a way as to be able to communicate with the printing apparatus, the control method including acquiring information about a paper size of a sheet on which to cause the printing apparatus to perform printing, determining, based on the information about the paper size, whether it is necessary to rotate an image which the information processing apparatus has instructed the printing apparatus to print, and if it is determined that it is necessary to rotate the image, without causing an operating system (OS) of the information processing apparatus to perform rotation of the image, causing the application program to perform the rotation.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a printing system.

FIGS. 2A, 2B, 2C, 2D, and 2E are hardware configuration diagrams in the printing system.

FIGS. 3A and 3B are diagrams illustrating an example of a sequence according to a first embodiment.

FIG. 4 is a flowchart illustrating an example of print workflow processing.

FIG. 5A is a flowchart illustrating an example of rotation responsibility determination processing.

FIG. 5B is a flowchart illustrating an example of rotation responsibility determination processing.

FIG. 5C is a flowchart illustrating an example of rotation responsibility determination processing.

FIG. 6 is a flowchart illustrating an example of determination processing which is performed with use of a rotation correspondence table.

FIG. 7 is a flowchart illustrating an example of page description language (PDL) conversion flag determination processing.

FIG. 8 is a diagram illustrating an example of a criterion for determining the presence or absence of a rotation capability.

FIG. 9 is a flowchart illustrating an example of PDL conversion processing.

FIG. 10A is a diagram illustrating an example of a communication packet serving as a printer capability response.

FIG. 10B is a diagram illustrating an example of a communication packet serving as a printer capability response.

FIG. 10C is a diagram illustrating an example of a communication packet serving as a printer capability response.

FIGS. 11A, 11B, and 11C illustrate examples of sheet feed directions in vertical writing and horizontal writing for a Nagagata envelope (a vertically elongated envelope).

FIG. 12 is a diagram illustrating an example of a print setting user interface (UI).

FIG. 13 is a diagram illustrating an example of a preview screen in the print setting UI.

FIG. 14 is a diagram illustrating an example of a method for rotating an image depending on respective paper sizes.

### DESCRIPTION OF THE EMBODIMENTS

Various embodiments, features, and aspects of the disclosure will be described in detail below with reference to the drawings.

### First Embodiment

In a first embodiment, an example in which, with regard to a case where a printer 104 does not have a capability of rotating an image, with priority given to determining that a print setting extension application 112 has a responsibility for rotation, an operating system (OS) 114 is prevented or reduced from performing rotation is described.

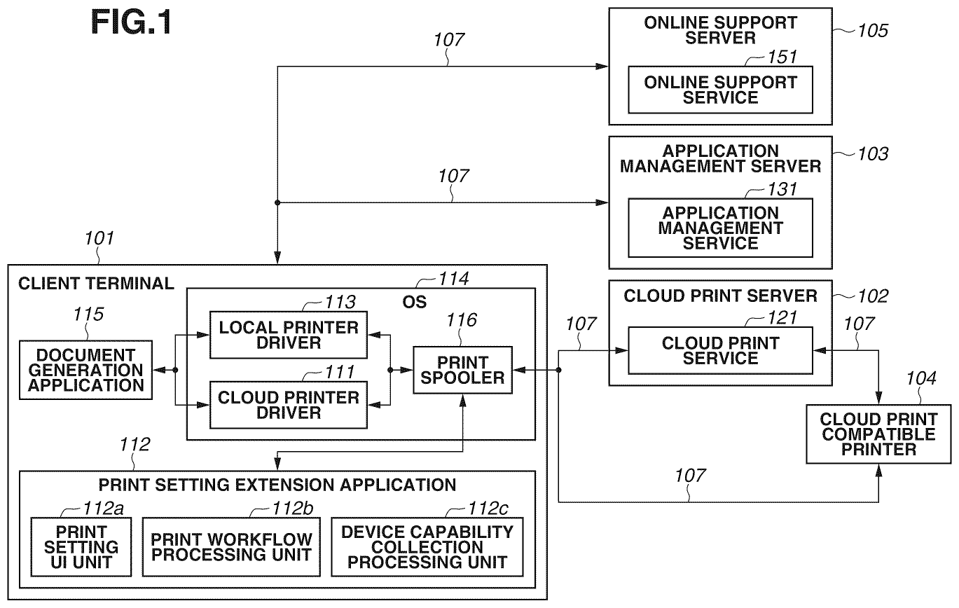

FIG. 1 is a configuration diagram of a printing system in cloud print and local print in the first embodiment. In the printing system, a client terminal 101, a cloud print server 102, an application management server 103, a cloud print compatible printer 104, and an online support server 105 are interconnected via a network 107 in such a way as to be able to communicate with each other.

The cloud print compatible printer 104 is also compatible with local print.

While, in FIG. 1, only one client terminal 101 and only one cloud print compatible printer 104 are illustrated, a plurality of client terminals 101 or a plurality of cloud print compatible printers 104 can be provided. The client terminal 101 is an example of an information processing apparatus, and the cloud print compatible printer 104 is an example of a printing apparatus.

Moreover, the cloud print server 102, the application management server 103, and the online support server 105 can be a server system composed of a plurality of information processing apparatuses. Combining the respective servers into a server system composed of a plurality of information processing apparatuses enables distributing a load to the plurality of information processing apparatuses.

Moreover, the cloud print server 102, the application management server 103, and the online support server 105 can be virtually configured inside a physically single information processing apparatus.

While the network 107 is assumed to be a wide area network (WAN), such as the Internet, the entirety of the network 107 can be located under a closed environment such as an internal (in-house) local area network (LAN).

The client terminal 101 is an information processing apparatus, such as a personal computer (PC), a tablet, or a smartphone, and is a terminal which the user is able to directly operate. The client terminal 101 is configured to allow optional application software to be executed.

A local printer driver 113 and a cloud printer driver 111 are drivers which are provided by the provider of the OS 114 of the client terminal 101. Moreover, the drivers 111 and 113 are printer drivers which generate print data which printers manufactured by a plurality of different manufactures (makers or vendors) are able to interpret.

The print setting extension application 112 is an application program which is provided by a vendor which is one of the above-mentioned plurality of printer vendors and provides a printer for use in printing.

The print setting extension application 112 is an application program which supports the local printer driver 113 or the cloud printer driver 111. The print setting extension application 112 extends functions concerning print settings of the local printer driver 113 or the cloud printer driver 111 via a print spooler 116 of the OS 114.

Specifically, (by performing processing operations in step S310 to step S312) the print setting extension application 112 extends functions concerning print settings of the local printer driver 113 or the cloud printer driver 111 via the print spooler 116 of the OS 114. The print setting extension application 112 extends the functions concerning print settings by merging device capability information included in the OS 114 itself and new added device capability information into new device capability information.

The cloud print compatible printer 104 is a device which actually performs printing on a recording medium such as a sheet of paper, and is an image forming apparatus which converts print data received via the network 107 into image data and then prints the image data.

A print setting user interface (UI) unit 112a is a print setting UI which the printer vendor has extended in the print setting extension application 112, and, instead of the cloud printer driver 111 or the local printer driver 113, provides a UI for print settings to the user.

The print setting UI unit 112a generates a print setting UI based on capability information which the OS 114 and the print setting extension application 112 have acquired from the cloud print compatible printer 104 or a cloud print service 121, and displays the generated print setting UI.

A print workflow processing unit 112b performs correction processing for setting information which has been set in the print setting UI. Moreover, the print workflow processing unit 112b performs, for example, correction processing for intermediate image data of an image or graphic expressed by, for example, the “Extensible Markup Language (XML) format, such as the XML Paper Specification (XPS) format, or page description language (PDL) conversion processing for converting such intermediate image data into a printer processable PDL.

In the print setting extension application 112, the print setting UI unit 112a performs, for example, collection of device capability information from, for example, the print spooler 116 or the cloud print compatible printer 104, editing or storing of a configuration information object, or processing for passing the configuration information object to the OS 114. The configuration information object is an aggregate of data groups required for editing device capability information.

The cloud print compatible printer 104 is able to both receive print data from the client terminal 101 via the cloud print server 102 and directly receive print data from the client terminal 101 without via the cloud print server 102.

The cloud print compatible printer 104 receives, via the cloud print server 102, print data which the cloud printer driver 111 of the client terminal 101 has generated. Moreover, the cloud print compatible printer 104 receives, without via the cloud print server 102, print data which the local printer driver 113 of the client terminal 101 has generated.

The cloud print server 102 receives a print instruction and print data from an external unit. Then, the cloud print server 102 transmits the received print data to the cloud print compatible printer 104 as designated.

The application management server 103 retains and manages various applications.

The application management server 103 receives identification information about an application and a download request therefor from the client terminal 101, and transmits, to the client terminal 101, an application which is identified based on the received identification information.

The online support server 105 is a server device which provides an online support service 151. The online support service 151 is a server device for providing, to the client terminal 101, a file in which information for extending the function of the client terminal 101 has been described.

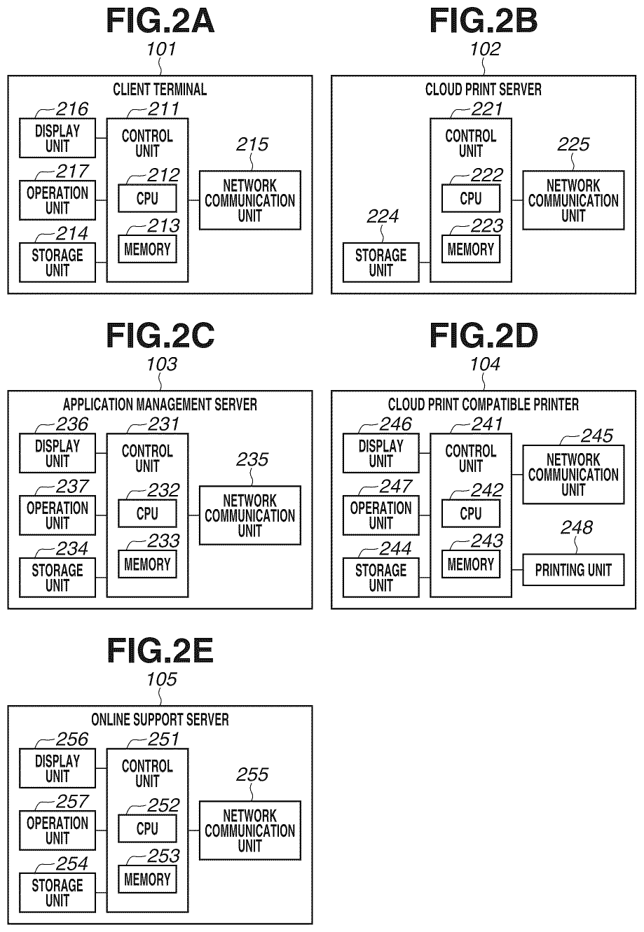

Next, hardware configurations in the printing system in the first embodiment are described with reference to FIGS. 2A, 2B, 2C, 2D, and 2E.

FIG. 2A is a block diagram illustrating a hardware configuration of the client terminal 101.

The client terminal 101 includes a display unit 216, an operation unit 217, a storage unit 214, a control unit 211, and a network communication unit 215.

The storage unit 214 is a non-volatile storage device such as a hard disk drive or solid state drive (SSD), and is able to store and rewrite digital data.

The control unit 211 includes a central processing unit (CPU) 212 and a memory 213, and controls the entire operation of the client terminal 101. The CPU 212 loads a program stored in the storage unit 214 onto the memory 213 and executes the loaded program. The memory 213 is a main storage memory for the CPU 212, and is used as a work area and a temporary storage region for loading various programs thereon.

The network communication unit 215 is a device which performs communication with the external network 107, and performs inputting and outputting of digital data with respect to, for example, an external server or an external client terminal via the network 107.

The display unit 216 is a device, such as a liquid crystal display, which displays visually recognizable information to the user in real time. The operation unit 217 is a device for receiving an input from the user, such as a keyboard and a mouse. A device which includes both functions of the display unit 216 and the operation unit 217, such as a touch panel, can be employed.

FIG. 2B is a block diagram illustrating a hardware configuration of the cloud print server 102. The cloud print server 102 includes a storage unit 224, a control unit 221, and a network communication unit 225.

The storage unit 224, the control unit 221, and the network communication unit 225 are equivalent to the respectively corresponding ones of the client terminal 101, and are, therefore, omitted from description here.

Furthermore, while, in the description of the first embodiment, the cloud print server 102 is configured with a single information processing apparatus having a hardware configuration illustrated in FIG. 2B, the cloud print server 102 can be configured with a plurality of information processing apparatuses each illustrated in FIG. 2B.

FIG. 2C is a block diagram illustrating a hardware configuration of the application management server 103. The application management server 103 includes a display unit 236, an operation unit 237, a storage unit 234, a control unit 231, and a network communication unit 235.

The display unit 236, the operation unit 237, the storage unit 234, the control unit 231, and the network communication unit 235 are equivalent to the respectively corresponding ones of the client terminal 101, and are, therefore, omitted from description here.

Furthermore, while, in the description of the first embodiment, the application management server 103 is configured with a single information processing apparatus having a hardware configuration illustrated in FIG. 2C, the application management server 103 can be configured with a plurality of information processing apparatuses.

FIG. 2D is a block diagram illustrating a hardware configuration of the cloud print compatible printer 104. The cloud print compatible printer 104 includes a display unit 246, an operation unit 247, a storage unit 244, a control unit 241, a network communication unit 245, and a printing unit 248.

The display unit 246 is a device for displaying information to the user in real time, such as a touch panel or a light-emitting diode (LED), provided at the cloud print compatible printer 104.

The operation unit 247 is an input device for receiving an input from the user, and may include, in addition to a touch panel, hardware keys such as a numeric keypad. The storage unit 244 and the control unit 241 are equivalent to the respectively corresponding ones of the client terminal 101 and are, therefore, omitted from description here.

The network communication unit 245 is a device which performs communication with the external network 107, and has the functions of mainly performing reception of print data and transmitting information indicating the status of the cloud print compatible printer 104, such as error information, to, for example, an external server.

The printing unit 248 is a device which performs print processing by performing a series of operations for paper feeding, printing, and paper discharging with respect to a sheet of paper prepared in a cassette or tray. The printing method is, for example, an electrophotographic method or an inkjet method, and is not particularly limited. The printing unit 248 also includes a duplex (double-sided) printing unit and a finishing device for, for example, stapling and punching, which are used at the time of discharging of paper.

Furthermore, while, in the first embodiment, as an example of the cloud print compatible printer 104, a single function printer for executing only a printing function is described, a multifunction printer (multifunction peripheral) which additionally has a scanner function and a facsimile (FAX) function can be employed.

FIG. 2E is a block diagram illustrating a hardware configuration of the online support server 105. In the description of the first embodiment, the online support server 105 is configured with a single information processing apparatus, the online support server 105 can be configured with a plurality of information processing apparatuses.

The online support server 105 includes a display unit 256, an operation unit 257, a storage unit 254, a control unit 251, and a network communication unit 255. The display unit 256 and the operation unit 257 are similar to the display unit 216 and the operation unit 217 of the client terminal 101 and are, therefore, omitted from description here. The storage unit 254 is a memory device such as an HDD or SSD. The storage unit 254 stores a file in which information for extending functions which are provided in the client terminal 101 has been described.

The control unit 251 includes a CPU 252 and a memory 253. The CPU 252 controls the entire online support server 105. The memory 253 is used for processing which is performed by the CPU 252. The network communication unit 255 is an interface used for the online support server 105 to perform communication with the client terminal 101. The online support server 105 receives, via the network communication unit 255, an acquisition request for a file stored in the storage unit 254, and transmits the corresponding file to the client terminal 101.

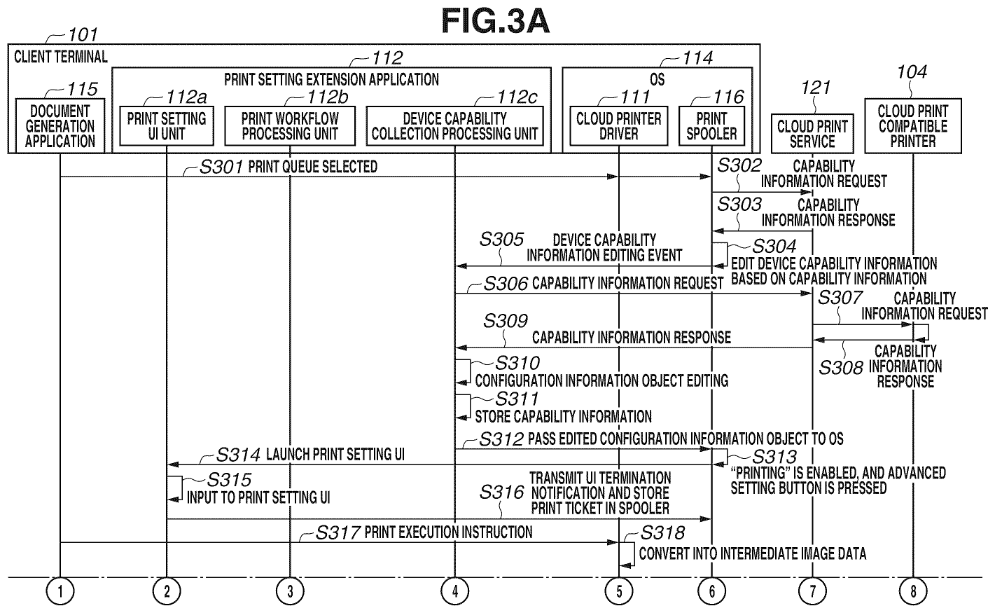

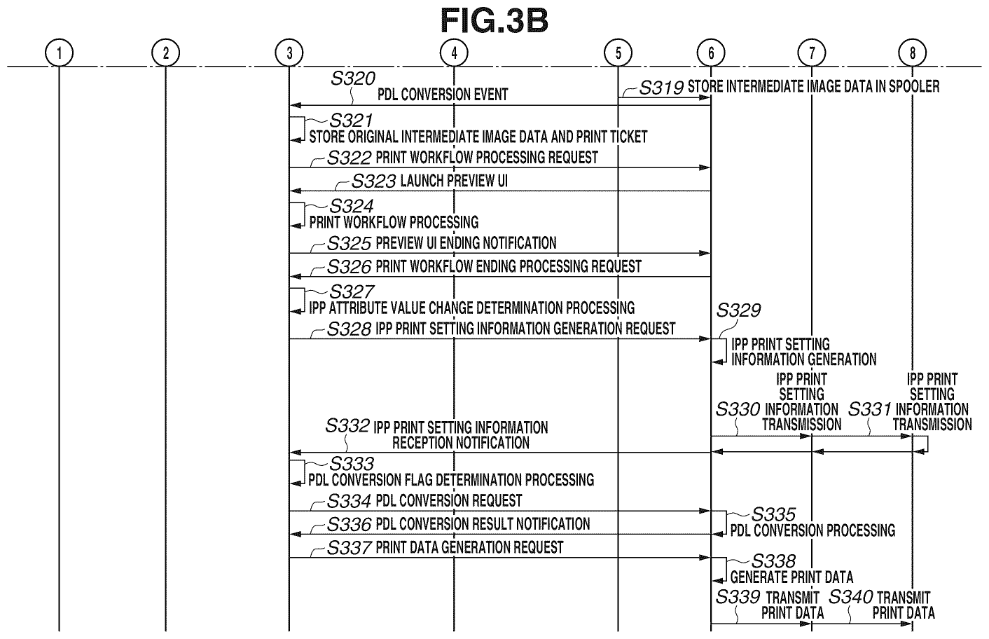

Next, an example of a sequence between a user's procedure, each piece of software, and a print service in the first embodiment is described with reference to FIGS. 3A and 3B.

In step S301, the print spooler 116 of the OS 114 receives selection of a print queue performed by the user, via a document generation application 115 and the cloud printer driver 111.

Next, in step S302, the OS 114 requests capability information about the cloud print compatible printer 104 from the cloud print service 121 via the print spooler 116. The capability information serving as a request target is determined by the OS 114 based on print setting items which the OS 114 itself supports. In the case of cloud print, the OS 114 requests the capability information determined as a request target from the cloud print service 121 with use of a standard protocol defined by the Internet Printing Protocol (IPP), such as Get-printer-Attributes.

In the case of cloud print, in step S303, the cloud print service 121 transmits, as a response, capability information about the cloud print compatible printer 104 to the OS 114. In the case of local print, the OS 114 directly requests the capability information from the cloud print compatible printer 104 without via the cloud print service 121 with use of a standard protocol defined by the Internet Printing Protocol (IPP), such as Get-printer-Attributes.

The OS 114 requests, as one of pieces of capability information serving as a request target, attributes regarding paper media retained in the cloud print compatible printer 104 with use of Get-printer-Attributes.

In the IPP, a media database information (media-col-database) attribute and a media feed completion information (media-col-ready) attribute are defined. In each of the pieces of attribute information, a media supply information (media-source-properties) attribute is defined. In a case where the cloud print compatible printer 104 is compatible with the media supply information attribute, the OS 114 acquires such attribute.

In a case where the cloud print compatible printer 104 is not compatible with the media supply information attribute, the OS 114 acquires information indicating the absence of such attribute. The OS 114 acquires media database information or acquires the media feed completion information attribute.

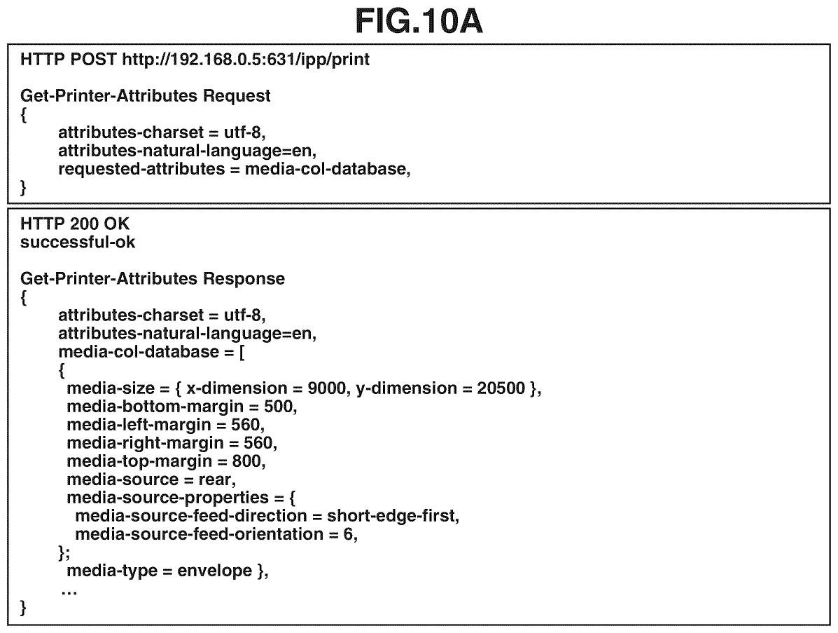

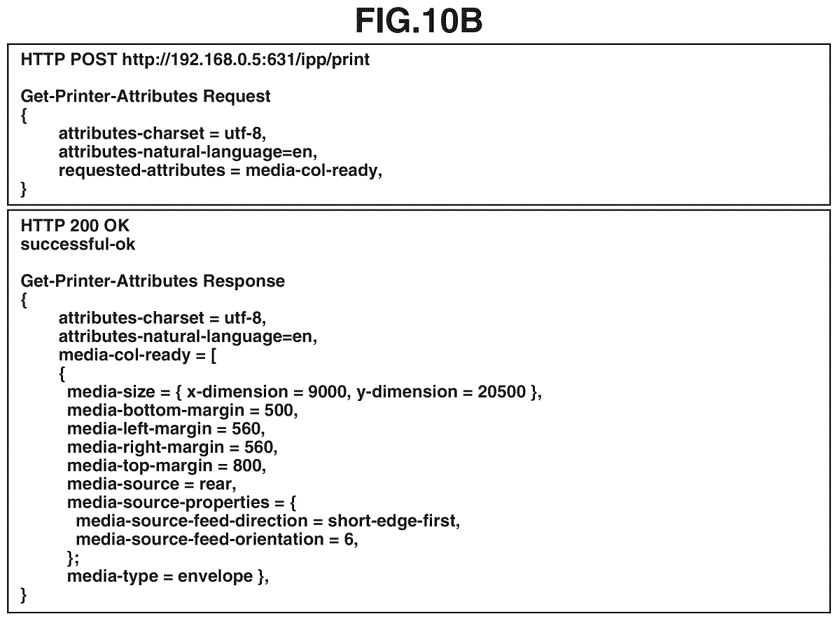

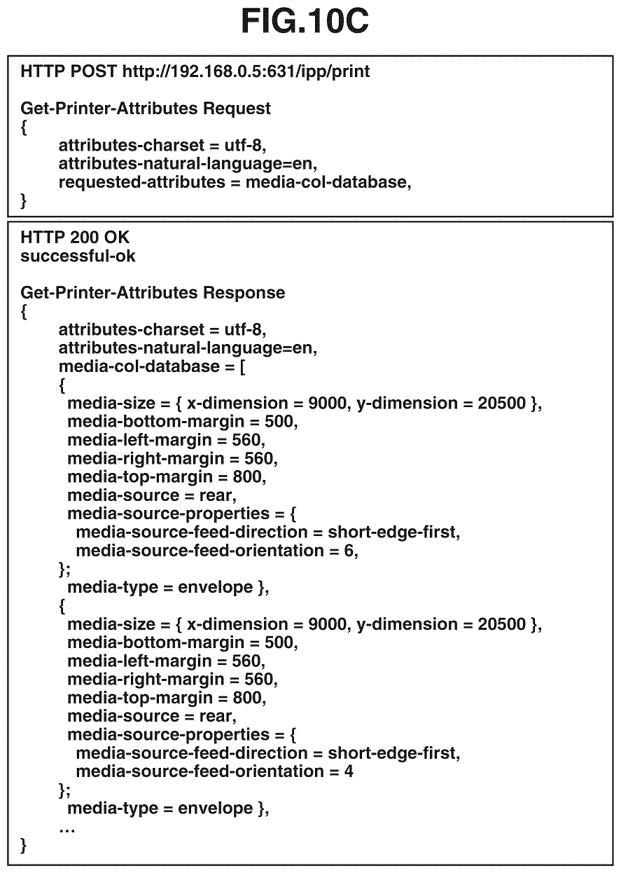

FIG. 10A illustrates an example of a request and response packet for acquiring capability information including the media supply information attribute from a printer's capability information response in the communication in step S302 and step S303 and the communication in step S307 and step S308.

The example illustrated in FIG. 10A is an example of a packet of the IPP protocol in which, in response to a Get-printer-Attributes request issued by the OS 114, the cloud print compatible printer 104 returns a Get-printer-Attributes response.

The media supply information attribute is present in information concerning the paper size (as an example, Envelope Nagagata 4 Gou (90×205 (mm)) of the media database information attribute included in a printer's response packet. The OS 114 acquires, from among information for each paper size, paper information including a media-source-feed-direction attribute value and a media-source-feed-orientation attribute value as member attributes of the media supply information attribute. In the example illustrated in FIG. 10A, the cloud print compatible printer 104 returns, as an example of a printer's response, the direction of paper being short-edge-first and the rotation angle of paper being 6: reverse-portrait.

Furthermore, instead of the media supply information attribute in the paper size of the media database information attribute included in a printer's response packet, the OS 114 can acquire the media supply information attribute in the media feed completion information (media-col-ready). FIG. 10B illustrates an example of the printer's response packet.

The media feed completion information has the advantage of enabling obtaining information about the paper media actually supplied to the printer and being smaller in data size than the media database information. Therefore, in a case where the OS 114 has not acquired the media database information or the media feed completion information, the print setting extension application 112 can acquire and register the media feed completion information.

In step S304, the OS 114 adds the capability information acquired in step S303 to the device capability information which the OS 114 itself retains.

Next, referring to FIGS. 3A and 3B, in step S305, the OS 114 notifies the print setting extension application 112 via the print spooler 116 of an event for enabling editing the device capability information. Upon receiving the notified event, the print setting extension application 112 becomes able to use an OS's application programming interface (API) available for editing device capability information.

Moreover, the notified event enables a device capability collection processing unit 112c of the print setting extension application 112 to directly acquire capability information which the OS 114 is not supporting from the cloud print service 121.

In step S306, upon receiving the device capability information editing event from the OS 114, the device capability collection processing unit 112c of the print setting extension application 112 requests capability information about the cloud print compatible printer 104 from the cloud print service 121.

At this time, the device capability collection processing unit 112c of the print setting extension application 112 selects, as the type of capability information serving as a request target, a type of capability which does not overlap the type of capability information which the OS 114 has requested, based on the type of capability information which is retained in the print setting extension application 112. Then, the device capability collection processing unit 112c of the print setting extension application 112 inquires of the cloud print service 121 about the capability information selected as a request target with use of a standard protocol defined by the Internet Printing Protocol (IPP), such as Get-printer-Attributes.

In this way, the print setting extension application 112 also becomes able to acquire capability information which is not supported by the OS 114.

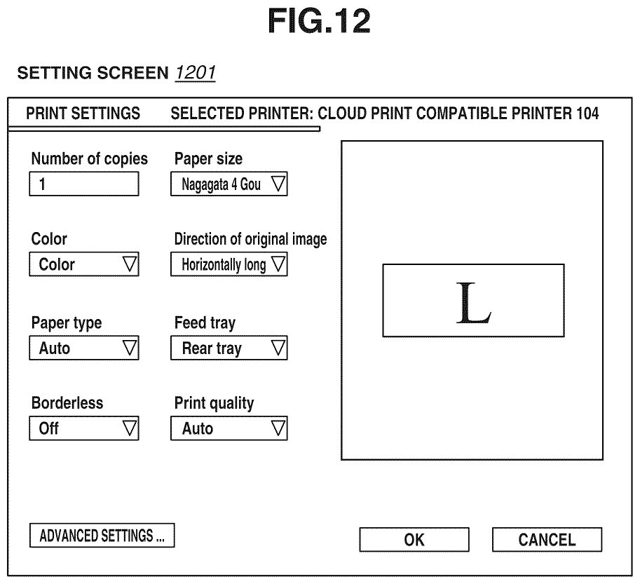

FIG. 12 illustrates an example of a graphical user interface (GUI) for print settings which the print setting UI unit 112a displays based on the capability information which the print setting extension application 112 has acquired.

The acquired capability information includes, for example, “rear tray” or “manual feed tray”, which is a setting value (option) for the setting item “feed tray” in the setting screen 1201 illustrated in FIG. 12. Moreover, to the setting item “paper type”, a vendor-specific setting value, such as “gloss pro grade” or “T-shirt transfer paper”, corresponds.

The method in step S306, as with that in step S302, designates, as an argument, “needleless binding”, “saddle binding”, or “bookbinding” with use of a standard protocol defined by the Internet Printing Protocol (IPP), such as Get-printer-Attributes.

The print setting extension application 112 requests, as one of pieces of capability information, an attribute concerning paper media which the cloud print compatible printer 104 retains, with use of Get-printer-Attributes. In the case of cloud print, the print setting extension application 112 acquires capability information from the cloud print compatible printer 104 with the intermediacy of the cloud print service 121, and, in the case of local print, the print setting extension application 112 directly acquires capability information from the cloud print compatible printer 104 without the intermediacy of the cloud print service 121.

The print setting extension application 112 acquires the media database information or acquires the media feed completion information attribute.

The media supply information attribute is included in each of pieces of attribute information, and, in a case where the cloud print compatible printer 104 is compatible with the media supply information attribute, the print setting extension application 112 acquires such attribute and, in a case where the cloud print compatible printer 104 is not compatible with the media supply information attribute, the print setting extension application 112 acquires information indicating the absence of the media supply information attribute.

In the case of cloud print, in step S307, the cloud print service 121, having received the request for capability information, requests capability information from the cloud print compatible printer 104 with use of the IPP protocol.

In step S308, the cloud print compatible printer 104 transmits, as a response, the requested capability information to the cloud print service 121.

In step S309, the cloud print service 121 transmits, as a response, the requested capability information to the device capability collection processing unit 112c of the print setting extension application 112.

In step S310, upon acquiring the vendor-specific capability information acquired from the cloud print compatible printer 104, the device capability collection processing unit 112c of the print setting extension application 112 edits the device capability information retained in the OS 114 via a configuration information object.

The configuration information object is an aggregate of data groups required for editing the device capability information.

The device capability collection processing unit 112c of the print setting extension application 112 is unable to directly edit the device capability information retained in the OS 114 and, therefore, changes the device capability information retained in the OS 114 with use of the configuration information object. At this time, in step S311, the device capability collection processing unit 112c of the print setting extension application 112 duplicates the capability information acquired by the device capability collection processing unit 112c itself and the capability information acquired by the OS 114 as device capability information data for the device capability collection processing unit 112c itself and stores the device capability information data in a data retention region of the print setting extension application 112.

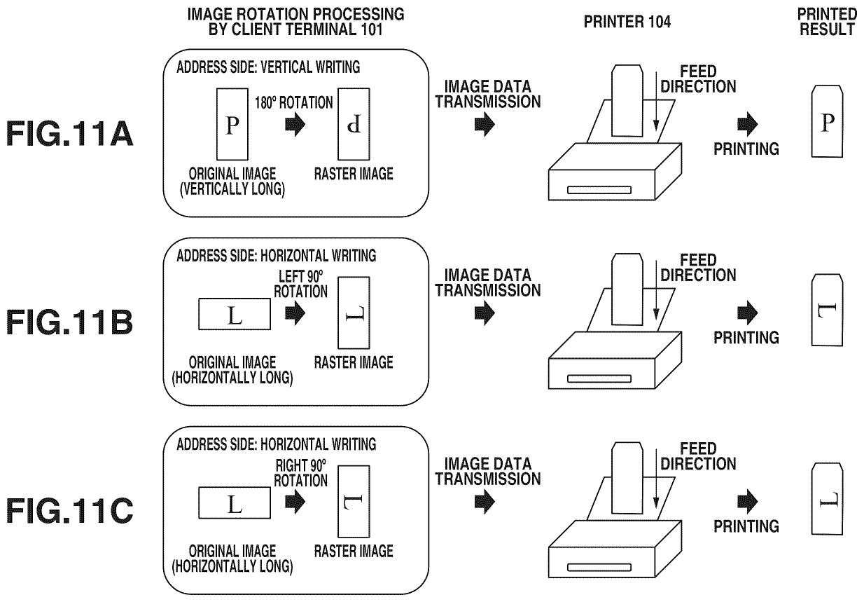

However, there are a case of performing vertical writing on an address side of envelope Nagagata 4 Gou, a case of performing horizontal writing on the address side with a flap of the envelope set to the right side of the envelope, and a case of performing horizontal writing on the address side with a flap of the envelope set to the left side of the envelope. In a case where the cloud print compatible printer 104 does not have a rotation capability, rotating a PWG-Raster image as illustrated in FIG. 11A, FIG. 11B, or FIG. 11C becomes required on the side of the client terminal 101.

As an example, in a case where the cloud print compatible printer 104 supports two rotation directions illustrated in FIG. 11A and FIG. 11B, the printer's response packet becomes like an IPP response packet illustrated in FIG. 10C. In a case where two rotation directions are available with respect to the paper size of envelope Nagagata 4 Gou, two rotation directions (6: reverse-portrait and 4: landscape) are included in the media supply information attribute.

Depending on OSs, it is not supposed to simultaneously acquire a plurality of image rotation angles with respect to capability information for one paper size, so that information about the rotation of device capability information edited by the print spooler 116 in step S304 may become an indefinite value.

Therefore, to correctly acquire a plurality of image rotation angles, the print setting extension application 112 can prioritize rotation information which the print setting extension application 112 has directly acquired from the cloud print compatible printer 104 with use of the IPP command in step S306. In that case, the print setting extension application 112 ignores rotation information included in the device capability information which the print spooler 116 has edited in step S304.

Next, in step S312, the device capability collection processing unit 112c of the print setting extension application 112 passes the edited configuration information object to the OS 114. Upon receiving the configuration information object from the device capability collection processing unit 112c of the print setting extension application 112, the OS 114 merges and updates the device capability information retained in the OS 114 itself and the device capability information added to the configuration information object into new device capability information.

Upon generating the new device capability information, in step S313, the OS 114 enables a print queue, so that the print setting UI unit 112a of the print setting extension application 112 is enabled to be launched.

In step S314, the print setting UI unit 112a included in the print setting extension application 112 is launched by the OS 114 and thus displays the setting screen 1201 such as that illustrated in FIG. 12. This print setting screen is able to display print setting information which the print setting extension application 112 supports, without depending on the type of the document generation application 115 to be used.

The print setting extension application 112 receives print setting information generated based on the print setting capability information which the OS 114 has generated from the device capability information, and displays the received print setting information as print settings in the setting screen 1201. At this time, the device capability information which the OS 114 has edited in step S304 and the capability information that is based on the capability information which the print setting extension application 112 has edited in step S310 and has passed to the OS 114 are passed to the print setting UI unit 112a. As a result, the user is allowed to select, designate, or set the function which the print setting extension application 112 has extended or added.

The print setting UI unit 112a included in the print setting extension application 112 provides the function of allowing the user to optionally change the print settings and, in a case where the print settings have been changed, stores the changed setting values. For example, suppose that the user has changed the setting value of the setting item “borderless” from “off” to “on” in the setting screen 1201. In that case, the print setting information which the print setting extension application 112 retains changes from “bordered”to “borderless”.

Then, if, in the setting screen 1201, an “OK” button has been pressed, the print setting extension application 112 closes the print setting UI unit 112a and completes a print setting operation in step S315. At this time, the print setting UI unit 112a writes the setting value set via the setting screen 1201 in a Print Ticket.

When the print setting extension application 112 has closed the setting screen 1201 and has completed the print setting operation, the operation screen for the user returns to a print setting screen which the document generation application 115 provides. On the other hand, the print setting UI unit 112a included in the print setting extension application 112 records the setting value set via the UI (setting screen 1201) in the Print Ticket. The Print Ticket is a file representing print setting information described in the XML format.

Then, in step S316, the print setting UI unit 112a transmits a UI termination notification with the Print Ticket appended thereto to the print spooler 116 of the OS 114, and completes processing in the print setting screen in the print setting extension application 112.

Next, in step S317, in response to the user issuing an instruction for printing via the document generation application 115, the cloud printer driver 111 of the OS 114 receives a print execution instruction.

Upon receiving the print execution instruction, in step S318, the cloud printer driver 111 converts the data received from the document generation application 115 into intermediate image data. The intermediate image data is data which is generated prior to being converted into print data such as a PDL, and is, for example, data in the XPS format.

In step S319, the intermediate image data generated by the cloud printer driver 111 is then stored in the print spooler 116 of the OS 114.

Upon receiving the intermediate image data, in step S320, the print spooler 116 of the OS 114 notifies the print workflow processing unit 112b included in the print setting extension application 112 of a PDL conversion event. The PDL conversion event represents processing for converting intermediate image data into a PDL processable by the cloud print compatible printer 104.

At the time of step S320, the print workflow processing unit 112b receives, from the print spooler 116 of the OS 114, with the notification of the PDL conversion event, the intermediate image data and the Print Ticket with the print setting values set by the print setting UI unit 112a recorded therein.

In step S321, the print workflow processing unit 112b sets the intermediate image data received in step S320 as “original intermediate image data” and then stores the original intermediate image data together with the Print Ticket in the data retention region of the print setting extension application 112.

Upon receiving the notification of the PDL conversion event, in step S322, the print workflow processing unit 112b requests the print spooler 116 of the OS 114 to perform print workflow processing. Here, the print workflow processing represents processing for performing, as needed, at least one of correction processing for setting information set via the print setting UI and editing and modifying processing for intermediate image data.

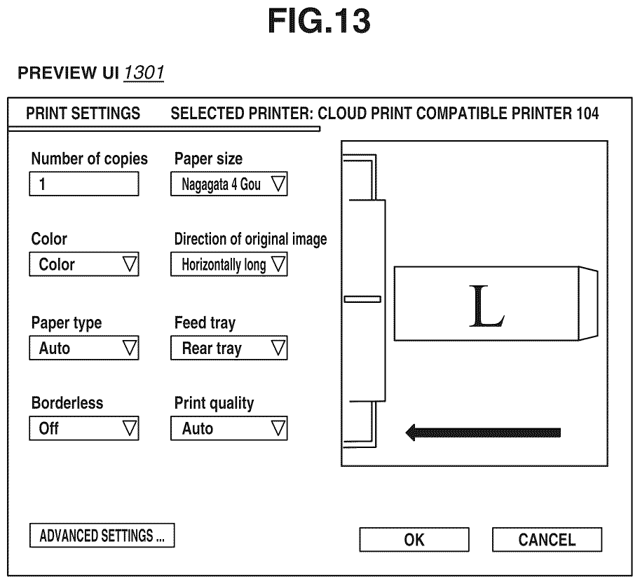

Upon receiving the request for print workflow processing, in step S323, according to the request content, the print spooler 116 of the OS 114 requests the print workflow processing unit 112b to launch a preview UI 1301 illustrated in FIG. 13.

Next, upon receiving the request for launching of the preview UI 1301, in step S324, the print workflow processing unit 112b performs the print workflow processing. The details of the print workflow processing (step S324) are described below.

Next, in step S325, the print workflow processing unit 112b notifies the print spooler 116 of the OS 114 of ending of the preview UI 1301.

In step S326, the print spooler 116 of the OS 114 requests the print workflow processing unit 112b to perform print workflow ending processing.

In step S327, the print workflow processing unit 112b performs, as the print workflow ending processing, IPP attribute value change determination processing for determining which IPP attribute value to change. The details of the IPP attribute value change determination processing (step S327) are described below.

Upon determining which IPP attribute value to change, in step S328, the print workflow processing unit 112b designates an IPP attribute to be changed and an IPP attribute value thereof with use of an API of the OS 114, and requests the print spooler 116 of the OS 114 to generate IPP print setting information.

The IPP print setting information represents print setting information defined by a combination of the IPP attribute and the IPP attribute value. For example, in a case where the setting value “rear tray” of the setting item “feed tray” has been selected, the IPP attribute becomes “media-source” and the IPP attribute value an instruction for which to issue to the cloud print compatible printer 104 becomes “rear”. Moreover, in a case where the setting value “normal” of the setting item “print quality” has been selected, the IPP attribute becomes “print-quality” and the IPP attribute value an instruction for which to issue to the cloud print compatible printer 104 becomes “normal”.

The description refers back to FIGS. 3A and 3B.

Next, in response to the request, in step S329, the print spooler 116 of the OS 114 generates IPP print setting information. Here, the print spooler 116 of the OS 114 generates IPP print setting information based on the Print Ticket, and, with respect to the IPP attribute designated for change, overwrites the IPP attribute value of the IPP print setting information according to the designation.

In step S330, the print spooler 116 of the OS 114 transmits the IPP print setting information to the cloud print service 121, and, in step S331, the cloud print service 121 transmits the IPP print setting information to the cloud print compatible printer 104. In the case of local print, the print spooler 116 of the OS 114 directly transmits the IPP print setting information to the cloud print compatible printer 104.

In the case of cloud print, in step S332, the cloud print compatible printer 104 notifies the print workflow processing unit 112b via the cloud print service 121 and the print spooler 116 of the OS 114 of the reception of the IPP print setting information. In the case of local print, the cloud print compatible printer 104 notifies the print workflow processing unit 112b via the print spooler 116 of the OS 114 of the reception of the IPP print setting information.

Next, in step S333, the print workflow processing unit 112b performs generation of printing intermediate image data and PDL conversion flag determination processing for determining a processing flag for use at the time of PDL conversion. The details of the PDL conversion flag determination processing (step S333) are described below.

Next, in step S334, the print workflow processing unit 112b passes the printing intermediate image data subjected to editing and modification and a PDL conversion control flag to the print spooler 116 of the OS 114, and thus requests the print spooler 116 of the OS 114 to perform conversion into a final PDL.

Next, in step S335, the print spooler 116 of the OS 114 performs PDL conversion processing with use of the printing intermediate image data subjected to editing and modification and the PDL conversion control flag. Furthermore, PDL conversion can be performed by the print setting extension application 112. The details of the PDL conversion processing (step S335) are described below.

After the PDL conversion processing (step S335), in step S336, the print workflow processing unit 112b receives, from the print spooler 116 of the OS 114, a final PDL as a PDL conversion result.

Next, in step S337, the print workflow processing unit 112b passes the final PDL to the print spooler 116 of the OS 114 and thus requests the print spooler 116 of the OS 114 to generate print data.

In step S338, the print spooler 116 of the OS 114 generates print data for transmitting the final PDL passed from the print workflow processing unit 112b to the cloud print compatible printer 104 by the IPP protocol.

In step S339, the print spooler 116 of the OS 114 transmits print data composed of the final PDL to the cloud print service 121 via a print queue. In the case of local print, the print spooler 116 of the OS 114 directly transmits print data composed of the final PDL to the cloud print compatible printer 104 via a print queue and without via the cloud print service 121.

In step S340, the cloud print service 121 transmits, to the cloud print compatible printer 104, the print data passed from the print spooler 116 of the OS 114.

Furthermore, while the processing in the sequence illustrated in FIGS. 3A and 3B is described for the case of cloud print as an example, with regard to the case of local print, equivalent processing can also be performed by directly communicating with the cloud print compatible printer 104 without via the cloud print service 121.

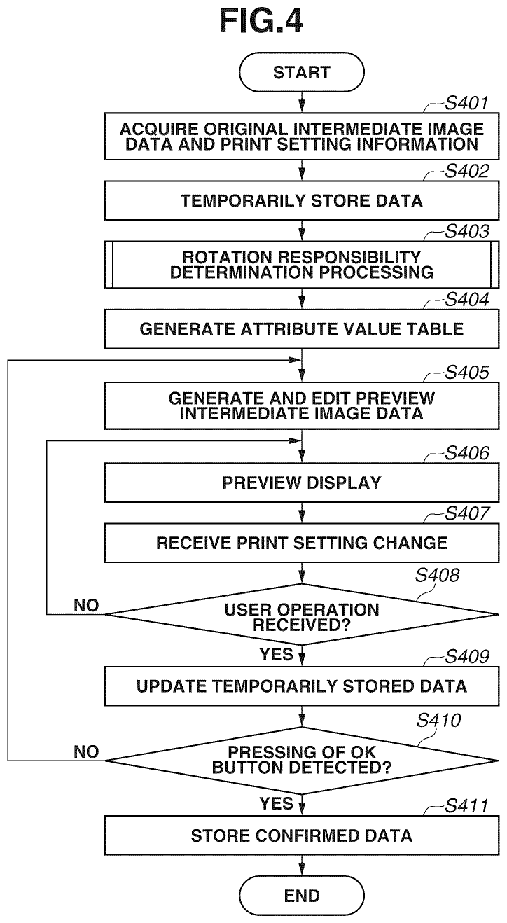

Next, the details of the print workflow processing (step S324) are described with reference to FIG. 4.

In the first embodiment, an example in which the print setting extension application 112, the OS 114, the cloud printer driver 111, and the local printer driver 113 are compatible with the PDF format and the PWG-Raster format as compatible PDL formats is described. However, since the PDL formats also include various other types of formats, the first embodiment is not limited to this example.

First, in step S401, the print workflow processing unit 112b reads out the original intermediate image data and the Print Ticket which have previously been stored in step S321.

Next, in step S402, the print workflow processing unit 112b temporarily retains, as temporarily stored print setting information in, for example, a storage region, the original intermediate image data and print setting information which has been extracted from the Print Ticket.

Next, in step S403, the print workflow processing unit 112b performs rotation responsibility determination processing. The details of the rotation responsibility determination processing (step S403) are described below.

After the above-mentioned rotation responsibility determination processing, in step S404, the print workflow processing unit 112b generates an attribute value table based on information about the print setting items retained in a program in the print setting extension application 112. The attribute value table includes items of a preview editing flag and items of the IPP attribute. The preview editing flag represents whether editing processing for intermediate image data has occurred at the time of preview displaying. In the column of the IPP attribute, an IPP attribute corresponding to a target print setting is stored.

An IPP attribute value an instruction for which to issue to the cloud print compatible printer 104 stores an IPP attribute value determined in the IPP attribute value change determination processing (step S327). The details of the IPP attribute value change determination processing (step S327) are described below.

After the attribute value table generation processing (step S404), the print workflow processing unit 112b duplicates the original intermediate image data temporarily stored in step S402. Then, in step S405, the print workflow processing unit 112b generates preview intermediate image data (XPS) and edits the preview intermediate image data based on the temporarily stored print setting information stored in step S402.

Next, in step S406, the print workflow processing unit 112b displays the intermediate image data subjected to editing processing on the preview UI 1301, and then in step S407, accepts changing of print settings via the preview UI 1301.

The print settings to be accepted via the preview UI 1301 do not need to be the same as the print settings which can be designated via the print setting UI (illustrated in FIG. 12). For example, a setting in which the main setting value is “auto”, such as “feed tray”or “discharge tray”, can be omitted from displaying on the preview UI 1301.

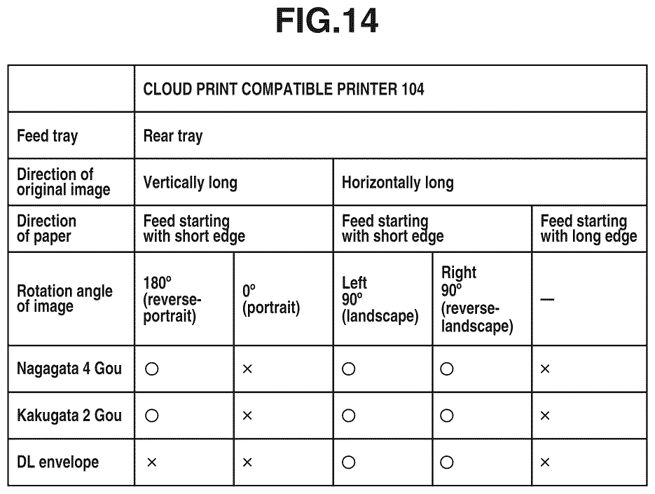

With regard to the preview UI 1301, image drawing is performed with the rotation angle of image and the direction of paper determined by referring to registration information such as a table of combination for rotating an image for each paper size illustrated in FIG. 14. The “rotation angle of image” illustrated in FIG. 14 represents a rotation angle corresponding to the direction of paper for the cloud print compatible printer 104 required to perform PDL conversion of print data to be transmitted to the cloud print compatible printer 104 into a PWG-Raster image in step S338. Therefore, the “rotation angle of image” is used not for rotating the preview intermediate image data itself but for reflecting the rotation angle of image in the preview displaying to visually check the direction of paper and the rotation angle of image subjected to printing.

While, in FIG. 14, only Nagagata 4 Gou, Kakugata 2 Gou (240×332 (mm)), and DL Envelope (220×110 (mm)) are shown as paper sizes, information about various sheets of paper for which the direction of printing is preliminarily determined, such as postcard and preprinted sheet, can be retained. Moreover, it can be considered that, with regard to plain paler of, for example, A4 size (210×297 (mm)), the first embodiment is also useful for a case where the direction of setting to a paper feed portion is selectable between vertical (portrait) orientation and horizontal (landscape) orientation.

For example, suppose that, in the setting screen 1201, “paper size”=Nagagata 4 Gou, “direction of original image”=horizontally long (Landscape), and “feed tray”=rear tray have been set. In that case, along capability information about the cloud print compatible printer 104 illustrated in FIG. 14, the feed direction to the cloud print compatible printer 104 of the paper size of Envelope Nagagata 4 Gou is required to be a direction in which paper feeding is performed with the bottom edge side of a physical medium of the envelope set as a head in paper feeding, as illustrated in FIG. 11A.

For example, consider a case where the “rotation angle of image” corresponding to the “direction of original image” and “direction of paper” illustrated in FIG. 14 is only 180 degrees (reverse-portrait). In that case, it can be determined that paper feeding is required to be performed with the bottom edge side of a physical medium to be fed set as a head in paper feeding, so that the image of a flap can be drawn at the back end of the medium to be fed.

To assist in enabling the user to visually check the direction of paper relative to the feed tray and the rotation angle of image, in the preview UI, with use of the direction of paper and the rotation angle of image included in the capability information, narrowing down of the direction of paper of the paper size selected in the “paper size” setting is performed. With use of the narrowed-down direction of paper and the rotation angle, visual auxiliary information is added to the preview screen. The print setting UI unit 112a draws, as the auxiliary information, a part of the feed tray and an arrow pointing from the preview image to the feed tray in superimposition on a corner in the preview screen. Drawing of the feed tray serving as the auxiliary information is displayed as an icon at the corner of the preview screen.

In the example illustrated in FIG. 13, according to the direction of paper and the rotation angle included in the capability information, the image of a part of the feed tray is drawn as an icon at the left side portion of the preview screen. Thus, according to the direction of paper and the rotation angle, a relative positional relationship between the feed tray and the direction of the preview image is drawn as auxiliary information at any one of the left side portion, right side portion, lower side portion, and upper side portion of the preview screen.

In this way, an image indicating a method of placing a sheet of paper on the feed tray is displayed. Moreover, an image indicating a printed result is displayed. Accordingly, even if the user does not know the meaning of each item in the print settings, based on a relative positional relationship between the printing apparatus and the preview intermediate image data subjected to editing processing, the user is able to visually check the direction of paper and the rotation angle of image subjected to printing.

Next, in step S408, the print workflow processing unit 112b performs detection of any user operation, and then continues the preview displaying (step S406) and the reception of print setting changing (step S407) until detecting a user operation.

If the print workflow processing unit 112b has detected a user operation (YES in step S408), the print workflow processing unit 112b determines that changing of the print settings has been performed, and then in step S409, the print workflow processing unit 112b updates the temporarily stored print setting information.

Then, until detecting pressing of the OK button in step S410, the print workflow processing unit 112b returns the processing to step S405 and thus repeats the editing processing of the intermediate image data, the preview display processing, and the print setting changing reception processing.

If, in step S410, the print workflow processing unit 112b has detected pressing of the OK button (YES in step S410), then in step S411, the print workflow processing unit 112b stores confirmed print setting information in the data retention region of the print setting extension application 112 (confirmed data storing processing). Here, the confirmed print setting information includes the original intermediate image data which has been previously stored in step S402 and the temporarily stored print setting information which has been updated in step S409. Moreover, here, according to the editing situation during previewing, the print workflow processing unit 112b also updates the attribute value table and stores the updated attribute value table in the data retention region of the print setting extension application 112.

With regard to updating of the attribute value table, specifically, in a case where editing processing of intermediate image data has occurred during preview displaying, the print workflow processing unit 112b enables a preview editing flag of an attribute value table of the corresponding print setting. Moreover, the print workflow processing unit 112b disables a preview editing flag of a print setting for which editing processing of intermediate image data has not occurred during preview displaying.

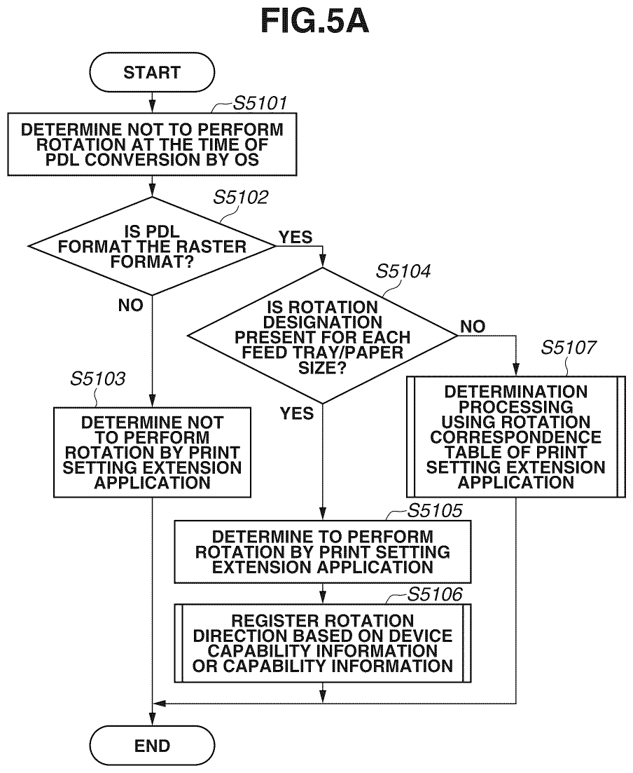

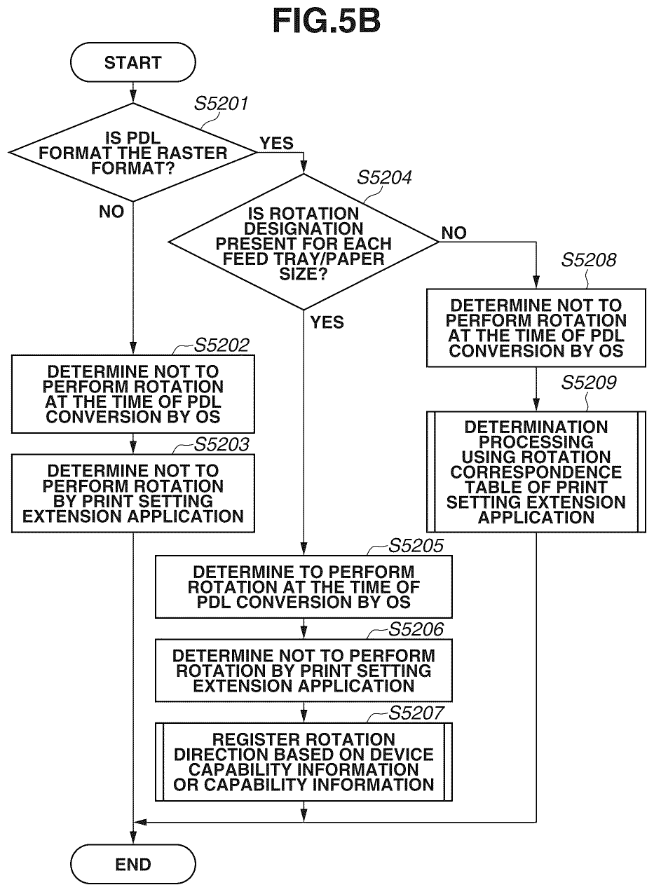

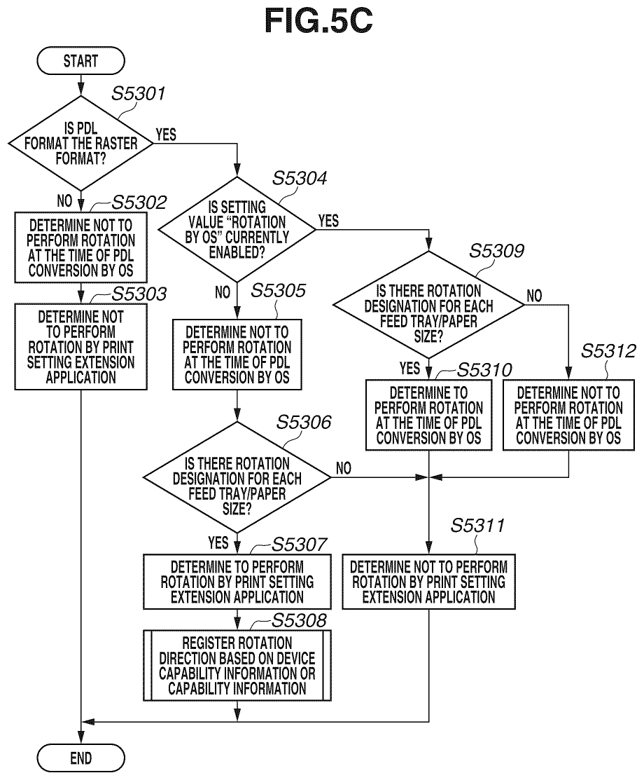

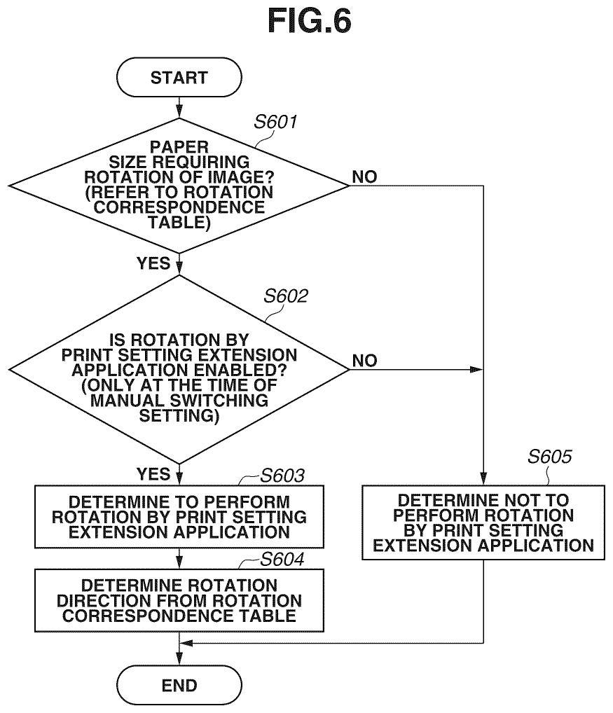

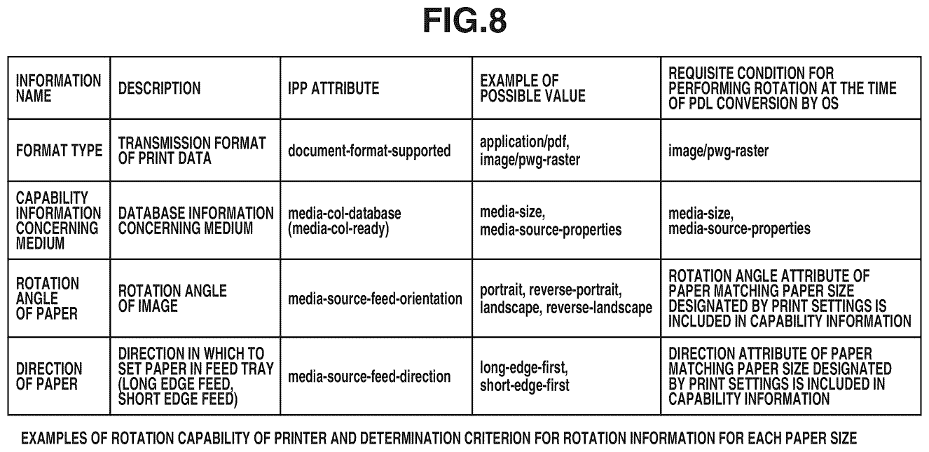

Next, the details of the rotation responsibility determination processing (step S403) are described with reference to FIG. 5A. The details of a determination criterion which is used in the rotation responsibility determination processing are also described additionally with reference to FIG. 6, FIG. 8, and FIG. 14.

FIG. 5A illustrates processing which is performed to prioritize a rotation following a setting value selected via the setting screen 1201 in the print setting extension application 112 and uniformly restrain a rotation which is performed by the OS 114. After restraining the rotation control, which is performed by the OS 114, when determining that the image rotation of the paper size concerned is required to be performed at the side of the client terminal 101, the print workflow processing unit 112b performs rotation control.

Therefore, at the beginning of the rotation responsibility determination processing (step S403), in step S5101, the print workflow processing unit 112b uniformly determines “not to perform rotation” at the time of PDL conversion performed by the OS 114.

The print workflow processing unit 112b reads out the capability information stored in step S311 and determines which of the cloud print compatible printer 104 and the client terminal 101 has a rotation responsibility. FIG. 8 illustrates an example of a rotation capability of a printer and a determination criterion for rotation information for each paper size, which are included in capability information acquirable from the printer.

As one of pieces of the capability information stored in step S311, i.e., information about the PDL format, there is “format type” (“document-format-supported”). Examples of “example of possible value” of the “format type” include PDF (Multipurpose Internet Mail Extensions (MIME) type=“application/pdf”) and PWG-Raster (MIME type=“image/pwg-raster”).

First, in step S5102, the print workflow processing unit 112b refers to the value of the capability information of the format type acquired from the cloud print compatible printer 104 and determines whether the PDL format is the raster format. If the format type is “application/pdf” (NO in step S5102), the print workflow processing unit 112b determines that the PDL format concerned is a PDL format for which the cloud print compatible printer 104 has a rotation responsibility.

Since the cloud print compatible printer 104 has a rotation responsibility, then in step S5103, the print workflow processing unit 112b determines not to perform rotation by the print setting extension application 112. While, since the cloud print compatible printer 104 has a rotation responsibility, it is necessary to determine not to perform rotation at the time of PDL conversion performed by the OS 114, such determination has already been performed in step S5101.

If the format type is “image/pwg-raster” (YES in step S5102), the print workflow processing unit 112b determines that the PDL format concerned is a PDL format for which the client terminal 101 has a rotation responsibility. Then, the print workflow processing unit 112b appropriately rotates an original image in such a way as to match the conveyance direction of each paper size with which the feed tray is compatible, then converts the rotated original image into a raster image for printing, and transmits the raster image.

Since the client terminal 101 has a rotation responsibility, the print workflow processing unit 112b checks whether there is rotation information for each paper size to which the print workflow processing unit 112b refers at the time of rotation by the print setting extension application 112. Therefore, the print workflow processing unit 112b checks the media supply information attribute acquired by the capability information request in step S302 from the cloud print compatible printer 104. The print workflow processing unit 112b refers to the member attributes of the IPP media supply information attribute illustrated in FIG. 8.

Then, in step S5104, the print workflow processing unit 112b determines the presence or absence of a “media-source-feed-orientation” attribute concerning “rotation angle of paper” and an IPP “media-source-feed-orientation” attribute concerning “direction of paper”.

The “direction of paper” represents from which of the short edge (short-edge-first) and the long edge (long-edge-first) to perform feeding at the feed tray of the printer (feed direction). The value of the “direction of paper” field uses an IPP media supply feed direction attribute (media-source-feed-direction) (possible values: long-edge-first and short-edge-first).

The “rotation angle of paper” is a capability response using a media supply feed angle attribute (media-source-feed-orientation) as a rotation angle by which the client terminal is requested to rotate an image based on a combination of the direction of an original image and the direction of paper. The possible values of the media supply feed angle attribute are portrait, reverse-portrait, landscape, and reverse-landscape.

Furthermore, there is a case where the rotation attribute included in the device capability information supports a custom definition capable of setting a rotation angle which is still not defined by the IPP attribute. In that case, a configuration in which rotation angles other than 0 degrees, left 90 degrees, right 90 degrees, and 180 degrees are able to be designated can be employed. In that case, a configuration in which the IPP attribute is uniquely extended, a rotation angle is preliminarily uniquely defined such as landscape-custom or printer-custom, and such defined rotation angle is able to be acquired from the printer capability information only needs to be employed. This enables implementing a vendor-specific print setting UI or print job editing function.

The print workflow processing unit 112b checks the presence or absence of the “media-source-feed-orientation” attribute, the “media-source-feed-direction” attribute, and the attribute values thereof for each paper size. Then, if both the paper rotation angle attribute value and the paper direction attribute value are present (YES in step S5104), then in step S5105, the print workflow processing unit 112b determines to perform rotation by the print setting extension application 112.

In step S5106, the print workflow processing unit 112b registers the “direction of paper” and “rotation angle of paper” possible for each paper size based on the media supply information attribute and member variables thereof acquired from the cloud print compatible printer 104 in the rotation responsibility determination processing (step S403).

Furthermore, in a case where mapping is performed from the IPP media sully information attribute to the rotation attribute in the device capability information retained in the OS 114, based on the acquired capability information, in step S304, the OS 114 edits the device capability information retained in the OS 114 itself. Alternatively, based on the acquired capability information, in step S312, the OS 114 merges and updates the device capability information retained in the OS 114 itself and the device capability information added to the configuration information object into new device capability information.

Therefore, the names of definition values of the rotation angles obtained before and after mapping may vary, so that the definition vales to be registered in step S5106 do not need to completely coincide with each other. For example, even if, in the IPP, the definition value is reverse-portrait, the rotation attribute in the device capability information retained in the OS 114 may be mapped to a different definition such as Portrait Flipped. Even if the name of the IPP attribute and the definition of device capability information converted in the OS 114 differ from each other, the print workflow processing unit 112b includes an attribute mapping correspondence table concerning rotation angles.

FIG. 14 illustrates an example of rotating an image for each paper size depending on a combination of options of setting items in the setting screen 1201 and the capability information about the cloud print compatible printer 104.

In an example in which the cloud print compatible printer 104 supports Nagagata 4 Gou, Kakugata 2 Gou, and DL Envelope in envelopes, each combination of print settings in which feeding is able to be performed from the rear tray of the cloud print compatible printer 104 is shown by the mark “○”.

The print workflow processing unit 112b refers to the rotation angle of image (“media-source-feed-orientation” attribute) acquired from the media supply feed angle attribute for each paper size/feed tray of the printer in the “rotation angle of image”. Then, the print workflow processing unit 112b registers information equivalent to the mark “○”or “x ”for each paper size with a table as illustrated in FIG. 14.

For example, suppose that, with regard to Nagagata 4 Gou, in the setting screen 1201, print settings of “direction of original image”=vertically long and “direction of paper”=feeding starting with short edge have been performed. In this case, the “rotation angle of image” available for printing with “paper size”=Nagagata 4 Gou is uniquely determined to be 180° (reverse-portrait).

However, referring to FIG. 8, it can be understood that, even if the “feed tray”, “direction of original image”, and “direction of paper” are determined with respect to a specific printer, there is a case where the “rotation angle of image” is not uniquely determined and two available combinations remain. For example, even if, in the case of performing printing with the paper size of Nagagata 4 Gou from the rear tray of a specific printer, “direction of original image”=horizontally long and “direction of paper”=feeding starting with short edge have been determined, two combinations for “rotation angle of image”=left 90° and “rotation angle of image”=right 90° remain.

In this case, a configuration in which a setting item concerning the rotation of image is displayed in the setting screen 1201 in such a way as to, with the left 90° rotation set as an initial value, enable changing such rotation to right 90° rotation in the setting screen 1201, so that the user can select “envelope: horizontal writing (left 90°)” or “envelope: horizontal writing (right 90°)”, can be employed.

Combinations of “direction of original image”, “direction of paper”, and “rotation angle of image” in which feeding is unable to be performed from the rear tray of the cloud print compatible printer 104 are shown by the mark “x ”in FIG. 14.

If, as a result of, in step S5104, checking the media supply information attribute acquired with the capability information request performed in step S302 from the cloud print compatible printer 104, it is impossible to acquire the media supply information attribute or the rotation designation is absent (NO in step S5104), then in step S5107, the print workflow processing unit 112b registers the rotation direction without use of the printer capability information.

Since the capability information is unable to be used for registration of the rotation direction, the print workflow processing unit 112b preliminarily stores a rotation correspondence table such as that illustrated in FIG. 14 in the storage unit 214 and then refers to the rotation correspondence table in the determination processing in step S5107.

FIG. 6 illustrates processing for performing determination in step S5107 with use of the rotation correspondence table stored in the storage unit 214. However, since, in the case of using the rotation correspondence table without using the capability information about the cloud print compatible printer 104, there is concern that, when the capability information about the cloud print compatible printer 104 has changed, the print workflow processing unit 112b may make a false operation, in a case where the print workflow processing unit 112b has been able to acquire necessary capability information, the print workflow processing unit 112b refers to the acquired capability information. However, since, depending on printers, there is a case where the printer is not compatible with the media supply information attribute, using the rotation correspondence table enables taking appropriate measures.

In step S601, the print workflow processing unit 112b acquires a paper size and a feed tray designated by the print setting information and determines whether the rotation of image by the print setting extension application 112 is necessary, by referring to the rotation correspondence table. Furthermore, in step S602, since a manual changeover switch for rotation control is not used in the first embodiment, the print workflow processing unit 112b determines that the print setting extension application 112 side is always enabled (YES in step S602).

If, in step S601, it is determined that the rotation of image is not necessary (NO in step S601), then in step S605, the print workflow processing unit 112b determines not to perform rotation by the print setting extension application 112. If, in step S601, it is determined that the rotation of image is necessary (YES in step S601), then in step S603, the print workflow processing unit 112b determines to perform rotation by the print setting extension application 112.

Since it has been determined that the rotation of image is necessary, then in step S604, the print workflow processing unit 112b refers to the “rotation angle of image” in the rotation correspondence table illustrated in FIG. 14 and thus registers the rotation direction. Furthermore, in the case of using the rotation correspondence table stored in the storage unit 214 and not using the capability information, the print workflow processing unit 112b determines the “rotation angle of image” with use of not the media supply information attribute acquired from the cloud print compatible printer 104 but the “rotation angle of image” stored in the storage unit 214.

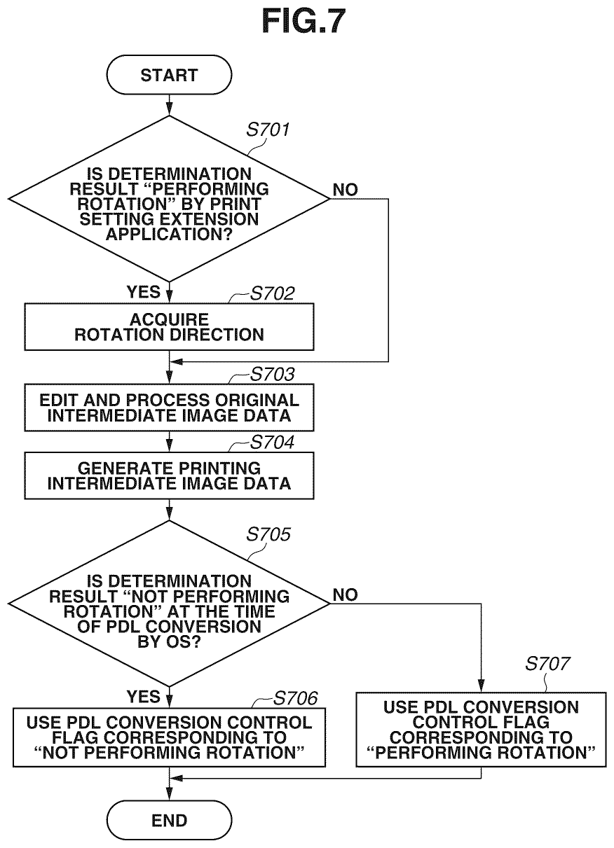

Next, the details of the PDL conversion flag determination processing (step S333) are described with reference to FIG. 7.

The print workflow processing unit 112b reads, from the data retention region of the print setting extension application 112, the original intermediate image data previously stored in step S321 and the confirmed print setting information previously stored in step S411.

In step S701, the print workflow processing unit 112b refers to a result of the rotation responsibility determination processing (step S403).

If the result is a determination result indicating “performing rotation” by the print setting extension application 112 (YES in step S701), then in step S702, the print workflow processing unit 112b acquires the rotation direction of image determined in step S5106 or step S604. Here, the rotation direction of image refers to designated values of the rotation angle of paper and the direction of paper corresponding to the paper size designated in the setting screen 1201 for print settings.

Then, in step S703 and step S704, the print workflow processing unit 112b performs editing processing on the original intermediate image data, performs the rotation of image using the rotation direction acquired in step S702, and then generates printing intermediate image data subjected to editing processing.

Furthermore, there is a case where the rotation attribute included in the device capability information supports a custom definition capable of setting a rotation angle which is still not defined by the IPP attribute. In that case, a configuration in which rotation angles other than 0 degrees, left 90 degrees, right 90 degrees, and 180 degrees are able to be designated can be employed. In that case, a configuration in which the IPP attribute is uniquely extended, a rotation angle is preliminarily uniquely defined such as landscape-custom or printer-custom, and such defined rotation angle is able to be acquired from the printer capability information only needs to be employed.

Then, in step S703, the print workflow processing unit 112b performs editing of the image according to the uniquely defined rotation angle. This enables implementing a vendor-specific print setting UI or print job editing function. Here, the original intermediate image data refers to intermediate image data which the cloud printer driver 111 has generated in step S318.

If the result in step S701 is a determination result indicating “not performing rotation” by the print setting extension application 112 (NO in step S701), the print workflow processing unit 112b does not perform editing of the rotation. Furthermore, if, in addition to rotation, there is processing or editing to be performed by the print setting extension application 112, the print workflow processing unit 112b performs such processing or editing in step S703.

If the result in step S705 is a determination result indicating “performing rotation” at the time of PDL conversion by the OS 114 (NO in step S705), then in step S707, the print workflow processing unit 112b determines to use a PDL conversion control flag corresponding to “performing rotation” as parameters used for the OS 114 to perform PDL conversion processing. If the result in step S705 is a determination result indicating “not performing rotation” at the time of PDL conversion by the OS 114 (YES in step S705), then in step S706, the print workflow processing unit 112b determines to use a PDL conversion control flag corresponding to “not performing rotation” as parameters used for the OS 114 to perform PDL conversion processing. The PDL conversion control flag is passed from the print setting extension application 112 to the OS 114.

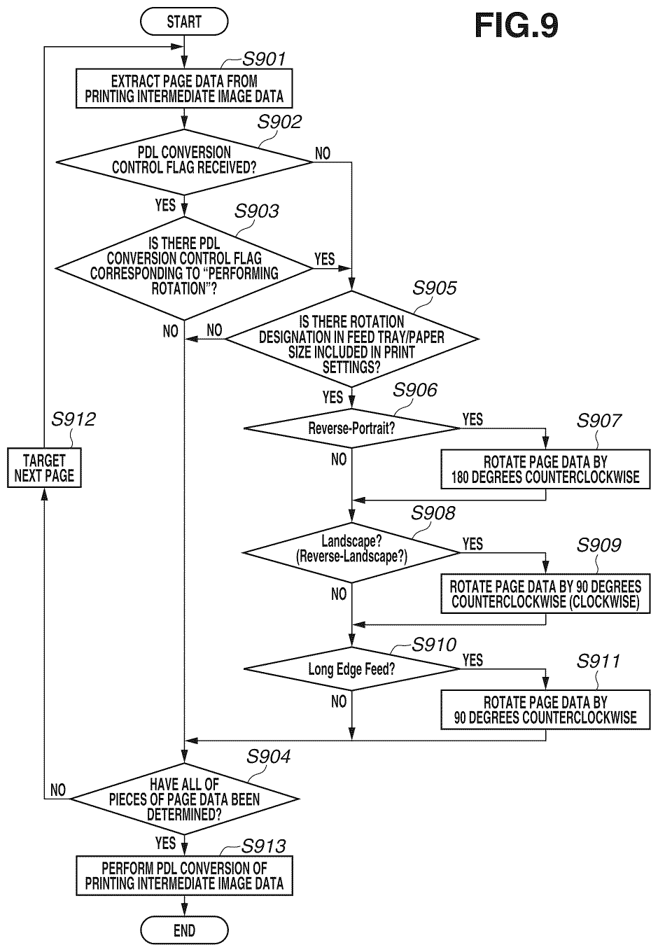

Next, the details of the PDL conversion processing (step S335) are described with reference to FIG. 9. Furthermore, PDL conversion described in the first embodiment is merely an example.

In the case of performing printing in the PWG-Raster format, as the responsibility of the client terminal 101 side, the client terminal 101 appropriately rotates an original image in such a way as to match the conveyance direction of each paper size with which the feed tray is compatible, converts the rotated image into a printing raster image, and then transmits the printing raster image. Therefore, in the case of performing printing in the PDF format, irrespective of the presence or absence of the media supply information attribute, the client terminal 101 does not perform rotation of image but the cloud print compatible printer 104 performs rotation of image.

First, in step S901, the print spooler 116 of the OS 114 extracts page data from the printing intermediate image data received from the print workflow processing unit 112b in step S334.

Next, in step S902, the print spooler 116 of the OS 114 determines whether the PDL conversion control flag has been received from the print workflow processing unit 112b in step S334.

If the PDL conversion control flag has been received (YES in step S902), then in step S903, the print spooler 116 of the OS 114 refers to the PDL conversion control flag and determines whether there is a registration corresponding to “performing rotation”. If the PDL conversion control flag has not been received (NO in step S902), then in step S905, the print spooler 116 of the OS 114 determines whether there is rotation designation in the media supply information attribute matching the feed tray/paper size set by the print settings.

The OS 114 has edited the device capability information in step S304 based on the media supply information attribute included in the capability information response (step S303). Therefore, in step S905, the print spooler 116 of the OS 114 determines whether there is rotation designation for each paper size, based on rotation information included in the edited device capability information. The print spooler 116 of the OS 114 determines the rotation angle of image with use of information including the paper size, feed tray, and paper type included in the print setting information and the device capability information.

Furthermore, in a case where mapping is performed from the IPP media sully information attribute to the rotation attribute in the device capability information retained in the OS 114, based on the acquired capability information, in step S304, the OS 114 edits the device capability information retained in the OS 114 itself. Alternatively, based on the acquired capability information, in step S312, the OS 114 merges and updates the device capability information retained in the OS 114 itself and the device capability information added to the configuration information object into new device capability information.

Therefore, the names of definition values of the rotation angles obtained before and after mapping may vary, so that the definition vales to be registered in step S5106 do not need to completely coincide with each other. For example, even if, in the IPP, the definition value is reverse-portrait, the rotation attribute in the device capability information retained in the OS 114 may be mapped to a different definition such as Portrait Flipped. Even if the name of the IPP attribute and the definition of device capability information converted in the OS 114 differ from each other, the OS 114 itself includes an attribute mapping correspondence table concerning rotation angles.

In step S906, the OS 114 determines whether the rotation angle of image to be designated is Reverse-Portrait designation included in the print setting information and the device capability information.

If, in step S906, the page data is Reverse-Portrait data (YES in step S906), then in step S907, the print spooler 116 of the OS 114 rotates the page data by 180 degrees counterclockwise.

If, in step S906, the page data is not Reverse-Portrait data (NO in step S906), the print spooler 116 of the OS 114 advances the processing to step S908. In step S908, the OS 114 determines whether the rotation angle of image to be designated is Landscape designation or Reverse-Landscape designation included in the print setting information and the device capability information.

If, in step S908, the rotation angle of image is Landscape designation (YES in step S908), then in step S909, the print spooler 116 of the OS 114 rotates the page data by 90 degrees counterclockwise. If, in step S908, the rotation angle of image is Reverse-Landscape designation (YES in step S908), then in step S909, the print spooler 116 of the OS 114 rotates the page data by 90 degrees clockwise.

In a case where there is any one of rotation designations in step S906, step S909, and step S910, the OS 114 performs, for each page, writing of information about the designated rotation angle of image in the Orientation attribute of header information of the PWG-Raster data.

If, in step S908, the rotation angle of image is neither Landscape designation nor Reverse-Landscape designation (NO in step S908), the print spooler 116 of the OS 114 advances the processing to step S910. In step S910, the print spooler 116 of the OS 114 refers to the print setting information received from the print workflow processing unit 112b in step S329, and determines whether the feed conveyance direction of the designated feed stage is Long Edge Feed.

The print spooler 116 of the OS 114 determines whether there is paper direction designation in the media supply information attribute matching the feed tray/paper size set by the print settings. The OS 114 has edited the device capability information in step S304 based on the media supply information attribute included in the capability information response (step S303). Therefore, in step S910, the print spooler 116 of the OS 114 determines whether there is paper direction designation for each paper size, based on direction information included in the edited device capability information.

The print spooler 116 of the OS 114 determines the direction of image with use of information including the paper size, feed tray, and paper type included in the print setting information and the device capability information. If, in step S910, the feed conveyance direction of the designated feed stage is Long Edge Feed (YES in step S910), then in step S911, the print spooler 116 of the OS 114 further rotates the page data 90 degrees counterclockwise.

If, in step S910, the feed conveyance direction of the designated feed stage is not Long Edge Feed (NO in step S910), the print spooler 116 of the OS 114 advances the processing to step S904.

Moreover, if, in step S902, the PDL conversion control flag has been received (YES in step S902), then in step S903, the print spooler 116 of the OS 114 determines whether the PDL conversion control flag is a flag corresponding to “performing rotation”.

If, in step S903, the PDL conversion control flag is a flag corresponding to “performing rotation” (YES in step S903), the print spooler 116 of the OS 114 performs processing operations in step S905 to step S913. If, in step S903, the PDL conversion control flag is not a flag corresponding to “performing rotation” (NO in step S903), then in step S904, without performing any processing on the page data, the print spooler 116 of the OS 114 determines whether all of the pieces of page data have been determined.

If, in step S904, all of the pieces of page data have been determined (YES in step S904), then in step S913, the print spooler 116 of the OS 114 performs PDL conversion of the printing intermediate image data. If, in step S904, any page data not yet determined is remaining (NO in step S904), then in step S912, the print spooler 116 of the OS 114 advances the processing to step S912, thus repeating processing operations in step S901 to step S904.

Next, the details of the IPP attribute value change determination processing (step S327) are described.

The print workflow processing unit 112b reads out the attribute value table from the data retention region of the print setting extension application 112. For example, in a case where the option “rear tray” of the setting item “feed tray” has been selected, the IPP attribute in the attribute value table becomes “media-source” and the IPP attribute value an instruction for which to issue to the cloud print compatible printer 104 becomes “rear” to be transmitted in the IPP protocol. For example, in a case where the option “normal” of the setting item “print quality” has been selected, the IPP attribute in the attribute value table becomes “print-quality” and the IPP attribute value an instruction for which to issue to the cloud print compatible printer 104 becomes “normal” to be transmitted in the IPP protocol.

As described above, according to the first embodiment, the print workflow processing unit 112b included in the print setting extension application 112 controls responsibility sharing with regard to PDL conversion performed by the OS 114 based on the capability of the cloud print compatible printer 104 and the rotation performed by the print setting extension application 112. Then, preventing or reducing unnecessary duplication of page rotations performed by the OS 114 and the print setting extension application 112 enables obtaining an intended printed result.

### Second Embodiment

In a second embodiment, an example in which, with regard to a case where the cloud print compatible printer 104 does not have an image rotation capability, determining that the OS 114 has a responsibility for rotation is prioritized, so that the rotation by the print setting extension application 112 is prevented or reduced, is described. Specific processing which is performed according to the second embodiment is described with reference to FIG. 5B. Here, only differences from the first embodiment are described. The system configuration and hardware configuration are the same as those in the first embodiment except for some portions and are, therefore, omitted from description here.

As a difference from the first embodiment, the details of the rotation responsibility determination processing (S403) are described with reference to FIG. 5B. The details of a determination criterion which is used in the rotation responsibility determination processing are also described additionally with reference to FIG. 6, FIG. 8, and FIG. 14. FIG. 5B illustrates processing which is performed to prioritize rotation control to be performed by the OS 114 and restrain rotation control to be performed by the print setting extension application 112.

The print workflow processing unit 112b reads out the capability information stored in step S311 and determines which of the cloud print compatible printer 104 and the client terminal 101 has a rotation responsibility. FIG. 8 illustrates an example of a rotation capability of a printer and a determination criterion for rotation information for each paper size, which are included in capability information acquirable from the printer.

As one of pieces of the capability information stored in step S311, i.e., information about the PDL format, there is “format type” (“document-format-supported”). Examples of “example of possible value” of the “format type” to be written include PDF (MIME type=“application/pdf”) and PWG-Raster (MIME type=“image/pwg-raster”).

First, in step S5201, the print workflow processing unit 112b refers to the value of the capability information of the format type acquired from the cloud print compatible printer 104 and determines whether the PDL format is the raster format. If the value of the capability information of the format type is “application/pdf” (NO in step S5201), the print workflow processing unit 112b determines that the PDL format concerned is a PDL format for which the cloud print compatible printer 104 has a rotation responsibility.

Since the cloud print compatible printer 104 has a rotation responsibility, then in step S5202, the print workflow processing unit 112b determines not to perform rotation at the time of PDL conversion performed by the OS 114. Then, in step S5203, since the cloud print compatible printer 104 has a rotation responsibility, the print workflow processing unit 112b determines not to perform rotation by the print setting extension application 112.

If the value of the capability information of the format type acquired from the cloud print compatible printer 104 is “image/pwg-raster” (YES in step S5201), the print workflow processing unit 112b determines that the PDL format concerned is a PDL format for which the client terminal 101 has a rotation responsibility. In this case, the print workflow processing unit 112b appropriately rotates an original image in such a way as to match the conveyance direction of each paper size with which the feed tray is compatible, then converts the rotated original image into a raster image for printing, and transmits the raster image.

Since the client terminal 101 has a rotation responsibility, the print workflow processing unit 112b checks whether there is rotation information for each paper size to which the print workflow processing unit 112b refers at the time of rotation by the OS 114, and, therefore, the print workflow processing unit 112b checks the media supply information attribute acquired by the capability information request in step S302. The print workflow processing unit 112b refers to the member attributes of the media supply information attribute. Then, in step S5204, the print workflow processing unit 112b determines the presence or absence of a “media-source-feed-orientation” attribute concerning “rotation angle of paper” and an IPP “media-source-feed-direction” attribute concerning “direction of paper”illustrated in FIG. 8.

Furthermore, since, depending on the type of the OS 114 or the version of the OS 114, the OS 114 may be incompatible with the image rotation using the media supply information attribute at the time of PDL conversion performed by the OS 114, if it is determined that the OS 114 is incompatible with such image rotation (NO in step S5204), then in step S5208, the print workflow processing unit 112b can determine not to perform rotation at the time of PDL conversion performed by the OS 114.

The descriptions of the “direction of paper” and “rotation angle of paper” illustrated in FIG. 8 are similar to those in the first embodiment.

The print workflow processing unit 112b checks the presence or absence of the “media-source-feed-orientation” attribute, the “media-source-feed-direction” attribute, and the attribute values thereof for each paper size. Then, if both the paper rotation angle attribute value and the paper direction attribute value are present (YES in step S5204), then in step S5205, the print workflow processing unit 112b determines to perform rotation by the OS 114.

Since the print workflow processing unit 112b has determined to perform rotation by the OS 114, then in step S5206, the print workflow processing unit 112b determines not to perform rotation by the print setting extension application 112.

In step S5207, the print workflow processing unit 112b registers the “direction of paper” and “rotation angle of paper” possible for each paper size based on the media supply information attribute and member variables thereof acquired from the cloud print compatible printer 104 in the rotation responsibility determination processing (step S403). The specific details thereof are similar to those in the first embodiment (see, for example, FIG. 6 and FIG. 14) and are, therefore, omitted from description here.

Next, the details of the PDL conversion processing (step S335) are described with reference to FIG. 9. Furthermore, PDL conversion described in the second embodiment is merely an example.

In the case of performing printing in the PWG-Raster format, as the responsibility of the client terminal 101 side, the client terminal 101 appropriately rotates an original image in such a way as to match the conveyance direction of each paper size with which the feed tray is compatible, converts the rotated image into a printing raster image, and then transmits the printing raster image. Therefore, in the case of performing printing in the PDF format, irrespective of the presence or absence of the media supply information attribute, the client terminal 101 does not perform rotation of image but the cloud print compatible printer 104 performs rotation of image.

First, in step S901, the print spooler 116 of the OS 114 extracts page data from the printing intermediate image data received from the print workflow processing unit 112b in step S334.

Next, in step S902, the print spooler 116 of the OS 114 determines whether the PDL conversion control flag has been received from the print workflow processing unit 112b in step S334.

If the PDL conversion control flag has been received (YES in step S902), then in step S903, the print spooler 116 of the OS 114 refers to the PDL conversion control flag and determines whether there is a registration corresponding to “performing rotation”.

Here, in the second embodiment, performing rotation by the OS 114 is prioritized, so that, in the control flow illustrated in FIG. 5B and in step S707, the PDL conversion control flag is set to “performing rotation”. Accordingly, in the PDL conversion by the OS 114, the rotation control operations in step S905 to step S913 are performed according to the respective determination processing operations.

The determination processing operations in step S905 to step S913 are the same as those in the first embodiment and are, therefore, omitted from description here.

As described above, according to the second embodiment, the print workflow processing unit 112b included in the print setting extension application 112 controls responsibility sharing with regard to PDL conversion performed by the OS 114 based on the capability of the cloud print compatible printer 104 and the rotation performed by the print setting extension application 112. Then, preventing or reducing unnecessary duplication of page rotations performed by the OS 114 and the print setting extension application 112 enables obtaining an intended printed result.

### Third Embodiment

In a third embodiment, an example in which, with regard to a case where the cloud print compatible printer 104 does not have an image rotation capability, which of the OS 114 and the print setting extension application 112 to cause to fulfill the responsibility for rotation is manually switched via a print setting UI provided in the print setting extension application 112 is described.

Specific processing which is performed according to the third embodiment is described with reference to FIG. 5C. Here, only differences from the first embodiment are described. The system configuration and hardware configuration are the same as those in the first embodiment except for some portions and are, therefore, omitted from description here.

As a difference from the first embodiment, the details of the rotation responsibility determination processing (S403) are described with reference to FIG. 5C. The details of a determination criterion which is used in the rotation responsibility determination processing are also described additionally with reference to FIG. 6, FIG. 8, and FIG. 14.

FIG. 12 illustrates a setting screen 1201 which is displayed by the print setting UI unit 112a of the print setting extension application 112. In response to an “advanced settings. ” button at the lower left of the setting screen 1201 being pressed, a setting item “rotation setting of image” is displayed. In the setting item “rotation setting of image”, a setting value can be selected and determined from options including “rotation by OS” and “rotation by print setting extension application”.

FIG. 5C illustrates an example of processing which is performed to manually switch which of the OS 114 and the print setting extension application 112 to cause to fulfill the responsibility for rotation, via a print setting UI provided in the print setting extension application 112.

Processing operations in step S5301, step S5302, and step S5303 of the print workflow processing unit 112b are the same as those in step S5201, step S5202, and step S5203 thereof in the second embodiment, and are, therefore, omitted from description here.

In step S5304, the print workflow processing unit 112b acquires a setting value of the setting item “rotation setting of image” from the setting screen 1201 (print setting UI unit 112a) and determines whether the setting value “rotation by OS”is currently enabled.

If, in step S5304, the setting value “rotation by OS” is currently enabled (YES in step S5304), the print workflow processing unit 112b checks whether there is rotation information for each paper size to which the print workflow processing unit 112b refers at the time of rotation by the OS 114, and, therefore, the print workflow processing unit 112b checks the media supply information attribute acquired by the capability information request in step S302. The print workflow processing unit 112b refers to the member attributes of the media supply information attribute.

Then, in step S5309, the print workflow processing unit 112b determines the presence or absence of a “media-source-feed-orientation” attribute concerning “rotation angle of paper” and an IPP “media-source-feed-direction” attribute concerning “direction of paper” illustrated in FIG. 8. The descriptions of the “direction of paper” and “rotation angle of paper”illustrated in FIG. 8 are similar to those in the first embodiment.

The print workflow processing unit 112b checks the presence or absence of the “media-source-feed-orientation” attribute, the “media-source-feed-direction” attribute, and the attribute values thereof for each paper size. Then, if both the paper rotation angle attribute value and the paper direction attribute value are present (YES in step S5309), then in step S5310, the print workflow processing unit 112b determines to perform rotation at the time of PDL conversion performed by the OS 114. Additionally, in step S5311, the print workflow processing unit 112b determines not to perform rotation by the print setting extension application 112.

Moreover, if the paper rotation angle attribute value or the paper direction attribute value is absent (NO in step S5309), then in step S5312, the print workflow processing unit 112b determines not to perform rotation at the time of PDL conversion performed by the OS 114.

If, in step S5304, the setting value “rotation by print setting extension application” is currently enabled (NO in step S5304), then in step S5305, the print workflow processing unit 112b determines not to perform rotation at the time of PDL conversion performed by the OS 114.

Additionally, in step S5306, as with the rotation designation presence/absence processing in step S5309, the print workflow processing unit 112b refers to the member attributes of the media supply information attribute and determines the presence or absence of the rotation designation attribute.

If the rotation designation is present (YES in step S5306), then in step S5307, the print workflow processing unit 112b determines to perform rotation by the print setting extension application 112. Moreover, in step S5308, as with step S5106 in the first embodiment, the print workflow processing unit 112b registers rotation information based on the device capability information or the capability information.

If the rotation designation is absent (NO in step S5306), then in step S5311, the print workflow processing unit 112b determines not to perform rotation by the print setting extension application 112.

As described above, according to the third embodiment, the print workflow processing unit 112b included in the print setting extension application 112 is able to control responsibility sharing with regard to PDL conversion performed by the OS 114 and the rotation performed by the print setting extension application 112, with use of manual switching via the print setting UI. Then, preventing or reducing unnecessary duplication of page rotations performed by the OS 114 and the print setting extension application 112 enables obtaining an intended printed result.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc^{TM} (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-144475 filed Aug. 26, 2024, which is hereby incorporated by reference herein in its entirety.

What is claimed is:

1. A non-transitory computer-readable storage medium storing an application program which causes an information processing apparatus to perform a control method, the information processing apparatus being connected to a printing apparatus in such a way as to be able to communicate with the printing apparatus, the control method comprising:
acquiring information about a paper size of a sheet on which to cause the printing apparatus to perform printing;
determining, based on the information about the paper size, whether it is necessary to rotate an image which the information processing apparatus has instructed the printing apparatus to print; and
if it is determined that it is necessary to rotate the image, without causing an operating system (OS) of the information processing apparatus to perform rotation of the image, causing the application program to perform the rotation.

2. The non-transitory computer-readable storage medium according to claim 1, wherein the control method further comprising, when causing the OS not to perform the rotation, using a page description language (PDL) conversion control flag for causing the OS not to perform the rotation.

3. The non-transitory computer-readable storage medium according to claim 1, wherein the control method further comprises displaying an image representing a method of placing the sheet on a feed portion of the printing apparatus according to the information about the paper size.

4. The non-transitory computer-readable storage medium according to claim 1, wherein the control method further comprises displaying an image representing a printed result appearing on the sheet.

5. The non-transitory computer-readable storage medium according to claim 1, wherein the control method further comprises performing the rotation on intermediate image data of the image and, after the rotation, converting the intermediate image data into print data.

6. The non-transitory computer-readable storage medium according to claim 1, wherein the sheet is at least one of an envelope, a postcard, and a preprinted sheet.

7. The non-transitory computer-readable storage medium according to claim 1, wherein the control method further comprises, if it is determined that the OS is not compatible with a function of image rotation, determining not to cause the OS to perform the rotation and causing the application program to perform the rotation.

8. The non-transitory computer-readable storage medium according to claim 1, wherein the control method further comprises, when determining whether it is necessary to rotate the image, referring to capability information acquired from the printing apparatus, the capability information designating a rotation angle of image and a feed direction of sheet.

9. A control method for an information processing apparatus connected to a printing apparatus in such a way as to be able to communicate with the printing apparatus, an application program installed on the information processing apparatus being executed to cause the information processing apparatus to perform the control method, the control method comprising:
acquiring information about a paper size of a sheet on which to cause the printing apparatus to perform printing;
determining, based on the information about the paper size, whether it is necessary to rotate an image which the information processing apparatus has instructed the printing apparatus to print; and
if it is determined that it is necessary to rotate the image, without causing an operating system (OS) of the information processing apparatus to perform rotation of the image, causing the application program to perform the rotation.

10. The control method according to claim 9, further comprising, when causing the OS not to perform the rotation, using a page description language (PDL) conversion control flag for causing the OS not to perform the rotation.

11. The control method according to claim 9, further comprising displaying an image representing a method of placing the sheet on a feed portion of the printing apparatus according to the information about the paper size.

12. The control method according to claim 9, further comprising displaying an image representing a printed result appearing on the sheet.

13. The control method according to claim 9, further comprising performing the rotation on intermediate image data of the image and, after the rotation, converting the intermediate image data into print data.

14. The control method according to claim 9, wherein the sheet is at least one of an envelope, a postcard, and a preprinted sheet.

15. The control method according to claim 9, further comprising, if it is determined that the OS is not compatible with a function of image rotation, determining not to cause the OS to perform the rotation and causing the application program to perform the rotation.

16. The control method according to claim 9, further comprising, when determining whether it is necessary to rotate the image, referring to capability information acquired from the printing apparatus, the capability information designating a rotation angle of image and a feed direction of sheet.

17. An information processing apparatus connected to a printing apparatus in such a way as to be able to communicate with the printing apparatus, the information processing apparatus comprising:
at least one memory that stores an application program installed on the information processing apparatus; and
at least one processor that executes the application program to cause the information processing apparatus to perform operations comprising:
acquiring information about a paper size of a sheet on which to cause the printing apparatus to perform printing;
determining, based on the information about the paper size, whether it is necessary to rotate an image which the information processing apparatus has instructed the printing apparatus to print; and
if it is determined that it is necessary to rotate the image, without causing an operating system (OS) of the information processing apparatus to perform rotation of the image, causing the application program to perform the rotation.
